(19) United States
(12) Patent Application Publication
(10) Pub. No.: US 2015/0178375 A1
(43) Pub. Date: Jun. 25, 2015

(54) METHOD FOR SEARCHING TREE USING INSTRUCTION OF OPERATING DATA HAVING PREDETERMINED MULTIPLE BIT WIDTHS

(71) Applicant: International Business Machines Corporation, Armonk, NY (US)

(72) Inventor: KAZUAKI ISHIZAKI, TOKYO (JP)

(21) Appl. No.: 14/556,514

(22) Filed: Dec. 1, 2014

(30) Foreign Application Priority Data
Dec. 19, 2013 (JP) 2013-262686

(51) Int. Cl. G06F 17/30

(52) U.S. Cl. CPC G06F 17/30598; G06F 17/30327

(57) ABSTRACT

Exemplary embodiments include methods and systems for searching a tree using an instruction of operating data having predetermined multiple bit widths. Aspects include constructing the tree by classifying nodes of the tree into groups having a minimum bit width capable of representing a value of a key among the multiple bit widths. Aspects further include searching for data in the group having the minimum bit width with a value of a search key being an effective number, using the instruction corresponding to the group having the minimum bit width with the value of the search key being the effective number.

This application claims priority to Japanese Patent Application No. JP2013-262686, filed 19 Dec. 2013, and all the benefits accruing therefrom under 35 U.S.C. §119, the contents of which in its entirety are herein incorporated by reference.

### BACKGROUND

The present invention relates to a technique of utilizing a degree of parallelism on an instruction level when finding a node into which a key is to be inserted or a node having a provided key in a tree structure. In particular, the present invention relates to a technique of searching a tree using an instruction of operating data having predetermined multiple bit widths.

A tree structure is used during search operations on a database or similar entities in order to enable a process of maintaining and storing a predetermined order of keys of data or a process of searching a provided data to be executed at high speed. It is required to find (i.e., identify) an internal node corresponding to a provided data in the tree structure when inserting or searching for data. An operation of finding the internal node is typically a search based on the value of a provided key through use of a data load instruction, a comparison instruction or a branch instruction. Speedup of the operation of finding the internal node is important for speedup of the tree structure processing.

### SUMMARY

Exemplary embodiments include methods and systems for searching a tree using an instruction of operating data having predetermined multiple bit widths. Aspects include constructing the tree by classifying nodes of the tree into groups having a minimum bit width capable of representing a value of a key among the multiple bit widths. Aspects further include searching for data in the group having the minimum bit width with a value of a search key being an effective number, using the instruction corresponding to the group having the minimum bit width with the value of the search key being the effective number.

It is thus an object of the present invention to enhance the speed of an operation of finding an internal node during data insertion or data search through use of an instruction of operating data having a predetermined bit width (e.g., a SIMD instruction).

### BRIEF DESCRIPTION OF THE SEVERAL VIEWS OF THE DRAWINGS

FIG. 1 is a diagram showing an example of a computer usable for an embodiment of the present invention;

FIG. 2 is a diagram showing an example of a tree structure constructed for using for a search technique 1 according to an embodiment of the present invention;

FIG. 3A is a diagram showing an example of a tree structure constructed for using for a search technique 2 according to an embodiment of the present invention;

FIG. 3B is a diagram showing an example of a tree structure constructed for using for the search technique 2 according to the embodiment of the present invention;

FIG. 3C is a diagram showing an example of a tree structure constructed for using for the search technique 2 according to the embodiment of the present invention;

FIG. 4A is a diagram showing Example 1 of dynamically reconstructing a tree by inserting an entry into a node of the tree in a tree structure constructed for use for the search technique 1 according to an embodiment of the present invention;

FIG. 4B is a diagram showing Example 1 of dynamically reconstructing the tree by inserting the entry into the node of the tree in the tree structure constructed for use for the search technique 1 according to the embodiment of the present invention;

FIG. 4C is a diagram showing Example 1 of dynamically reconstructing the tree by inserting the entry into the node of the tree in the tree structure constructed for use for the search technique 1 according to the embodiment of the present invention;

FIG. 4D is a diagram showing Example 1 of dynamically reconstructing the tree by inserting the entry into the node of the tree in the tree structure constructed for use for the search technique 1 according to the embodiment of the present invention;

FIG. 4E is a diagram showing Example 2 of dynamically reconstructing the tree by inserting an entry into a node of a tree in a tree structure constructed for use for the search technique 1 according to the embodiment of the present invention;

FIG. 4F is a diagram showing Example 2 of dynamically reconstructing the tree by inserting the entry into the node of the tree in the tree structure constructed for use for the search technique 1 according to the embodiment of the present invention;

FIG. 4G is a diagram showing Example 2 of dynamically reconstructing the tree by inserting the entry into the node of the tree in the tree structure constructed for use for the search technique 1 according to the embodiment of the present invention;

FIG. 4H is a diagram showing Example 2 of dynamically reconstructing the tree by inserting the entry into the node of the tree in the tree structure constructed for use for the search technique 1 according to the embodiment of the present invention;

FIG. 5A is a diagram showing Example 1 of dynamically reconstructing a tree by inserting an entry into a node of a tree in a tree structure constructed for use for the search technique 2 according to an embodiment of the present invention;

FIG. 5B is a diagram showing Example 1 of dynamically reconstructing the tree by inserting the entry into the node of the tree in the tree structure constructed for use for the search technique 2 according to the embodiment of the present invention;

FIG. 5C is a diagram showing Example 2 of dynamically reconstructing a tree by inserting an entry into a node of a tree in a tree structure constructed for use for the search technique 2 according to an embodiment of the present invention;

FIG. 5D is a diagram showing Example 2 of dynamically reconstructing the tree by inserting the entry into the node of the tree in the tree structure constructed for use for the search technique 2 according to the embodiment of the present invention;

FIG. 5E is a diagram showing Example 2 of dynamically reconstructing the tree by inserting the entry into the node of the tree in the tree structure constructed for use for the search technique 2 according to the embodiment of the present invention;

FIG. 6 shows a flowchart of entire processes of searching a tree using an instruction of operating data having predetermined multiple bit widths according to an embodiment of the present invention;

FIG. 7A shows a flowchart of processes of finding a leaf node where the value of a key is to be inserted or a leaf node with a possibility of having the value of a key using a tree structure for the search technique 1 according to an embodiment of the present invention;

FIG. 7B shows a flowchart of processes of finding a leaf node where the value of a key is to be inserted or a leaf node with a possibility of having the value of a key using a tree structure for the search technique 2 according to the embodiment of the present invention;

FIG. 8A shows a flowchart of processes of dynamically reconstructing a tree by inserting an entry into a node of a tree in a tree structure constructed for use for the search technique 1 according to an embodiment of the present invention;

FIG. 8B shows a flowchart of processes of dynamically reconstructing a tree by inserting an entry into a node of a tree in a tree structure constructed for use for the search technique 2 according to an embodiment of the present invention; and

FIG. 9 is a diagram showing an example of a functional block diagram of a computer that preferably includes a hardware configuration according to FIG. 1 and is for searching a tree using an instruction of operating data having predetermined multiple bit widths according to an embodiment of the present invention.

### DETAILED DESCRIPTION

The present invention relates to a technique of searching a tree using an instruction of operating data having predetermined multiple bit widths. This technique may encompass a method of searching a tree using an instruction of operating data having predetermined multiple bit widths, and a computer, a computer program and a computer program product that are for searching the tree.

It is required to predict that a tree structure preliminarily has a large amount of data owing to recent increase in the amount of data to be processed. Thus, the bit width of a key sometimes becomes large. An example of an actual product is IBM (registered trademark) Cognos (registered trademark) Business Intelligence 10.2. This product has a data structure where data is stored in a predetermined order. A tree is used for the data structure. Keys of this data structure are long and BigInteger (unchangeable integers with any precision) of Java (registered trademark) in consideration of possibility that the integer value may be large.

Many recent processors (e.g., Haswell of Intel Corporation, POWER7 of International Business Machines Corporation, K10 of Advanced Micro Devices, Inc., and a CPU based on the ARM architecture of ARM Holdings) have Single Instruction Multiple Data (SIMD) instructions that simultaneously apply the same process to multiple data elements having predetermined bit widths by one instruction. At this time, the total number of bit widths of multiple data elements has an upper limit. The upper limit is, for instance, 128 or 256 in POWER7.

In an operation of finding an internal node during data insertion or data search, high speed processing can be achieved for data loading or data comparison using a SIMD instruction. However, achievement of a high speed through use of the SIMD instruction has the following problems.

In the case of a large data width of a key (e.g., 64 bits), the degree of parallelism of an instruction level is not large even with use of a SIMD instruction (e.g., in the case where the register width of a SIMD instruction is 128, the degree of parallelism is 2=(128/64)). Accordingly, the degree of speedup is small.

Some architectures of processors do not support an operation for a large data width (e.g., POWER7 cannot compare 64 bits by one instruction). Accordingly, even with use of a SIMD instruction, the degree of speedup is small.

Embodiments of the present invention are described below with reference to the drawings. Throughout the following drawings, the same symbols indicate the same entities unless otherwise noted. The embodiments of the present invention are for describing preferred embodiments of the present invention. It should be noted that there is no intention to limit the scope of the present invention to what is described herein.

A “computer” usable for the embodiments of the present invention may be any computer which can execute processes of searching a tree using an instruction of operating data having predetermined multiple bit widths. The computer may be, for instance, a desktop computer, a note computer, an integrated personal computer or a tablet terminal, or a server computer.

In the embodiments of the present invention, an “instruction of operating data having predetermined multiple bit widths” is an instruction capable of applying the same process to multiple data elements with predetermined bit widths by one instruction. This instruction may be, for instance, an instruction capable of applying the same process to multiple data elements with predetermined bit widths by one instruction simultaneously or sequentially. The instruction capable of simultaneously applying the same process to multiple data elements with predetermined bit widths by one instruction is, for instance, a SIMD instruction. SIMD instructions may be those included in SSE or NEON.

In the embodiments of the present invention, a “minimum bit width capable of representing the value of a key” is, for instance, an 8-bit width, a 16-bit width, a 32-bit width, a 64-bit width, a 128-bit width or a 256-bit width.

In the embodiments of the present invention, a “tree” may be any tree in which a tree structure includes multiple child nodes and intermediate nodes having keys associated with the respective child nodes. The tree is, for instance, a B+ tree, a B-tree, a B* tree, a 2-3 tree, or a 2-3-4 tree.

Each of the B+ tree, the B-tree, the B* tree, the 2-3 tree, and the 2-3-4 tree is one type of a tree structure capable of performing insertion, search or deletion through designation of a key.

The B+ tree is a dynamic hierarchical index. Each index segment (also referred to as a “block” and corresponding to a node in a tree structure) has an upper limit and a lower limit of the number of keys. The B+ tree is different from the B− tree in that all records are stored in the leaf nodes residing at the bottom layer of the tree. Only a representative key is stored in an intermediate node (internal node). According to the B+ tree, an intermediate node has multiple pairs of a key and a child node. A leaf node has the value of a key to be searched.

In comparison with a simple binary tree, the B-tree stores multiple data entries in one block. Accordingly, the B-tree can narrow the range affected by change in the form of a tree structure even with addition of a data entry.

The B* tree is a type of a tree structure derived from the B-tree, and nodes other than a root node are in a state of being ⅔ full instead of ½ in the B-tree.

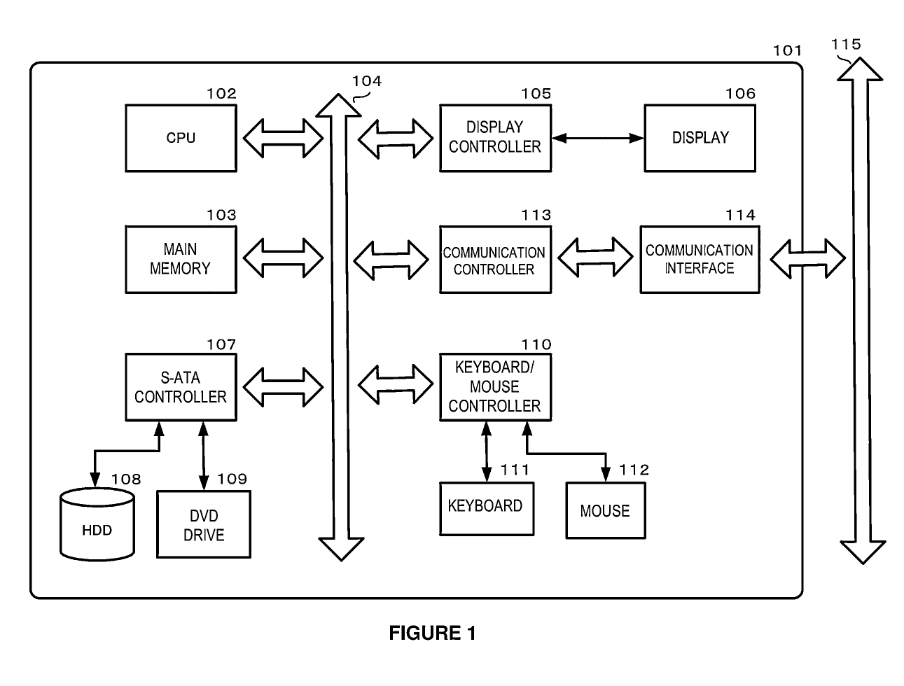

FIG. 1 is a diagram showing an example of a computer usable for an embodiment of the present invention.

The computer (101) includes one or multiple CPUs (102) and a main memory (103), which are connected to a bus (104). Preferably, the CPU (102) is based on a 32-bit or 64-bit architecture. The CPU (102) may be, for instance, Core (trademark) i series, Core (trademark) series, Atom (trademark) series, Xeon (registered trademark) series, Pentium (registered trademark) series or Celeron (registered trademark) series of Intel Corporation, A Series, Phenom (trademark) series, Athlon (trademark) Series, Turion (registered trademark) series or Sempron (trademark) of AMD (Advanced Micro Devices), Inc., or Power (trademark) series of International Business Machines Corporation.

A display (106), for instance, a liquid crystal display (LCD), may be connected to the bus (104) via a display controller (105). The liquid crystal display (LCD) may be, for instance, a touch panel display or a floating touch display. The display (106) is usable for displaying objects that are to be displayed by operation of software operating on the computer (101) (e.g., a computer program according to the embodiment of the present invention or various computer programs operating on the computer (101)) through an appropriate graphic interface.

A disk (108), e.g., a hard disk or a solid state drive (SSD), may be arbitrarily connected to the bus (104) via, e.g., a SATA or an IDE controller (107). A drive (109), e.g., a CD, DVD or BD drive, may be arbitrarily connected to the bus (104) via, e.g., the SATA or the IDE controller (107). A keyboard (111) and a mouse (112) may be arbitrarily connected to the bus (104) via a peripheral device controller (110), e.g., a keyboard/mouse controller or a USB bus. The disk (108) may store an operating system, e.g., Windows (registered trademark), Mac OS (registered trademark) X, Linux (registered trademark), Android (registered trademark), iOS, Java (registered trademark) processing environment including J2EE, Java (registered trademark) application, Java (registered trademark) virtual machine (VM), a program providing Java (registered trademark) just-in-time (JIT) compiler, a computer program according to the embodiment of the present invention and another program, and data, in a manner capable of being loaded on the main memory (103).

The disk (108) may be embedded in the computer (101), connected via a cable to the computer (101) in an accessible manner, or connected via a wired or wireless network to the computer (101) in an accessible manner. The drive (109) is usable for installing a program, e.g., an operating system, an application or a computer program according to the embodiment of the present invention into the disk (108) from a CD-ROM, a DVD-ROM or a BD, as required. A communication interface (114) is conformity with, for instance, the Ethernet (registered trademark) protocol. The communication interface (114) is connected to the bus (104) via a communication controller (113), performs a function of wire or wireless connection of the computer (101) to a communication line (115), and provides a network interface layer for the TCP/IP communication protocol of the communication function of the operating system of the computer (101). The communication line may be, for instance, a wireless LAN environment in conformity with a wireless LAN connection standard, a Wi-Fi wireless LAN environment, such as of IEEE802.11a/b/g/n, or a mobile phone network environment (e.g., the 3G or 4G environment).

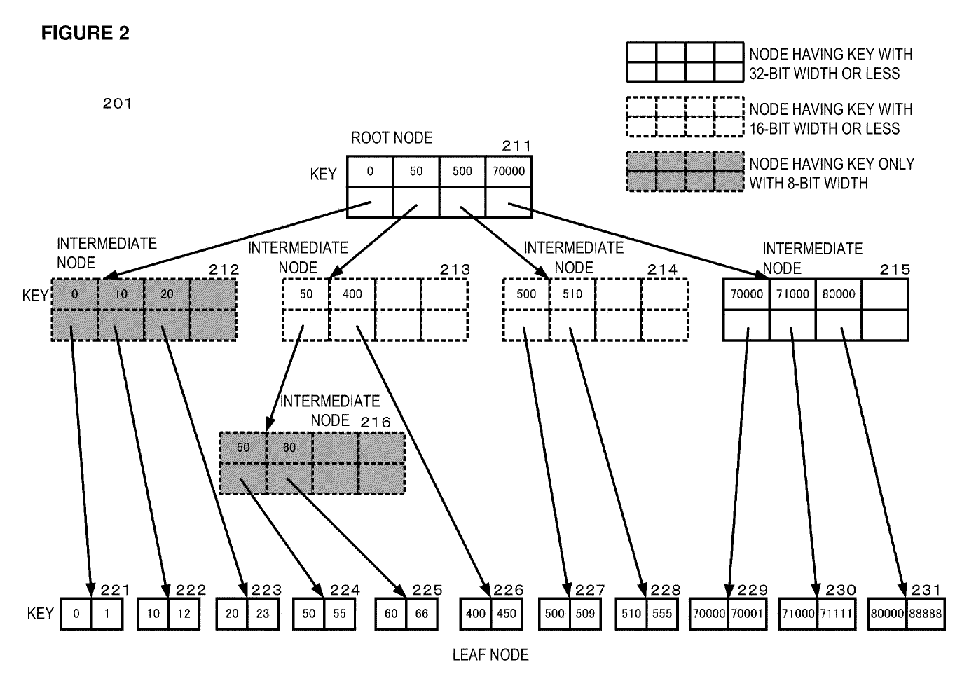

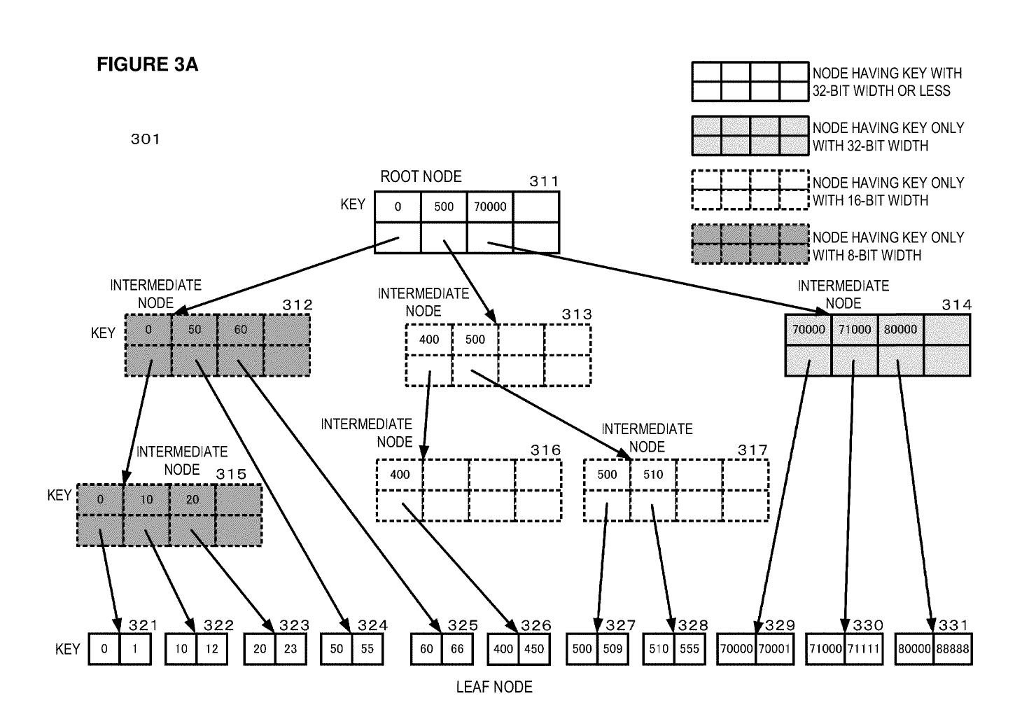

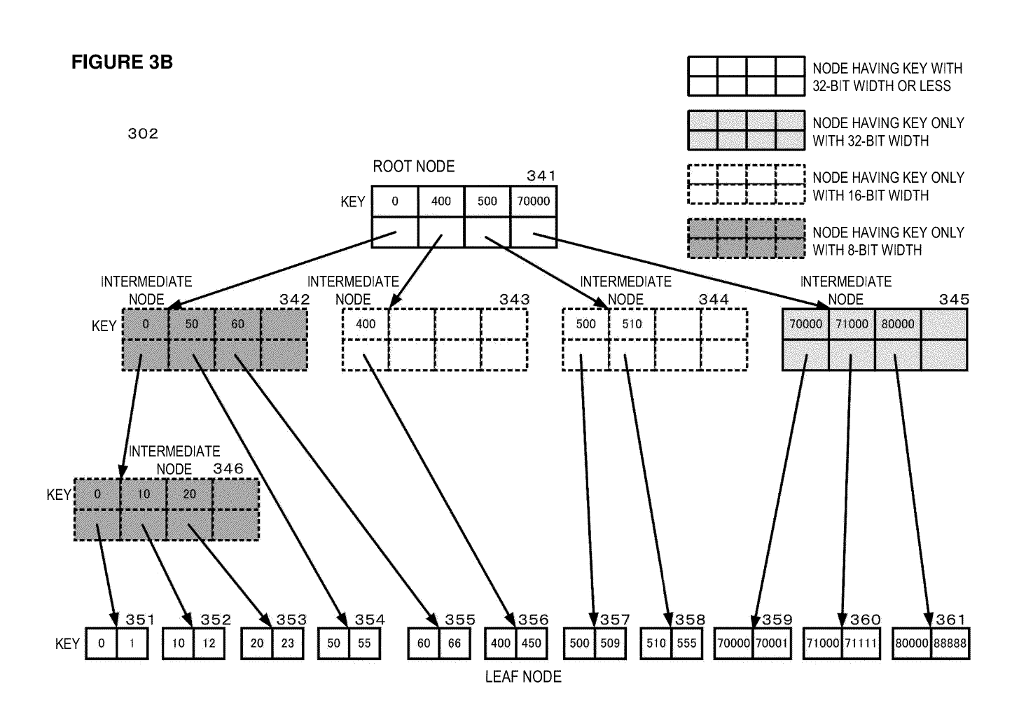

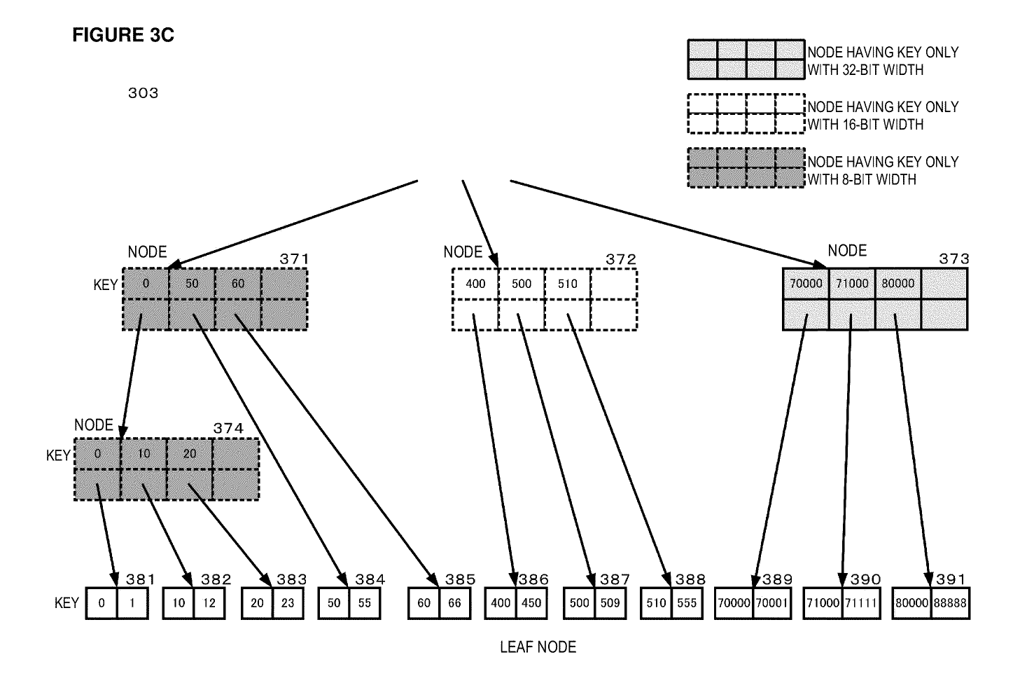

The following FIGS. 2 and 3A to 3C show examples of tree structures constructed for use for the search techniques according to the embodiments of the present invention. The search techniques according to the embodiments of the present invention include two modes, which are hereinafter referred to as a search technique 1 and a search technique 2. FIG. 2 shows a tree structure (201) constructed for use for the search technique 1. FIGS. 3A to 3C show tree structures (301, 302 and 303) constructed for use for the search technique 2.

In the tree structure (201) constructed for use for the search technique 1 according to the embodiment of the present invention, a certain intermediate node A sometimes have, as a child node, an intermediate node B belonging to a group (a group having a key with a bit width smaller or larger than the bit width of a group to which the intermediate node A belongs) different from a group to which the intermediate node A belongs. For comparison of keys through a node determination operation for the tree structure, in the case of comparison between a provided key value and the key values of a node through traversing of child nodes, the search technique 1 allows comparison through use of a SIMD comparison instruction that can check the group to which the node belongs and more appropriately utilize an instruction level degree of parallelism according to the group of the keys of the node (i.e., the range of values of the keys that the node has).

In the tree structures (301, 302 and 303) constructed for use for the search technique 2 according to the embodiment of the present invention, it is secured that a certain intermediate node A only has, as a child node, an intermediate node B in the group (i.e., a group having a key with the same bit width as the bit width of the group to which the intermediate node A belongs) identical to the group to which the intermediate node A belongs.

FIG. 2 is a diagram showing an example of a tree structure constructed for using for the search technique 1 according to the embodiment of the present invention. A tree (201) includes a root node (211), intermediate nodes (212 to 216), and leaf nodes (221 to 231). The root node (211) is a node at the top of the tree (201). Accordingly, the root node (211) has no parent node. The root node (211) can have multiple (four in the shown example) keys as entries. The root node (211) is connected to the intermediate nodes (212 to 216) directly or indirectly by edges. The entries of the root node (211) have the key values of the leftmost entries of the respective intermediate nodes (212, 213, 214 and 215) connected to the root node (211) directly by edges.

The intermediate nodes (212 to 216) are nodes having child nodes, and other than the root node (211) and the leaf nodes (221 to 231). Each of the intermediate nodes (212 to 216) can have one or multiple (four in the shown example) keys as entries. The intermediate nodes (212 to 216) are connected to the root node (211) and the leaf nodes (221 to 231) directly or indirectly by edges. The intermediate node is also referred to as an internal node.

The leaf nodes (221 to 231) are nodes at the bottom of the tree (201). Accordingly, the leaf nodes (221 to 231) have no child node. Each of the leaf nodes (221 to 231) can have one or multiple (two in the shown example) keys as entries. The leaf nodes (221 to 231) store data.

The root node (211) and the intermediate nodes (212 to 216) are classified into nodes in the following three groups as groups having a minimum bit width capable of representing the value of a key:

(1) nodes having a key with a 32-bit width or less (i.e., capable of having a key with any bit width);
(2) nodes having a key with a 16-bit width or less; and
(3) nodes having a key only with an 8-bit width.

The example of a tree (201) shown in FIG. 2 illustrates the case of classification into nodes of three groups. Alternatively, classification into nodes of a different number of groups are allowed according to the minimum bit width capable of representing the value of a key, for instance, four groups (nodes having a key with a 64-bit width or less; nodes having a key with a 32-bit width or less; nodes having a key with a 16-bit width or less; and nodes having a key only with an 8-bit width), five groups (nodes having a key with a 128-bit width or less; nodes having a key with a 64-bit width or less; nodes having a key with a 32-bit width or less; nodes having a key with a 16-bit width or less; and nodes having a key only with an 8-bit width), or six groups (nodes having a key with a 256-bit width or less; nodes having a key with a 128-bit width or less; nodes having a key with a 64-bit width or less; nodes having a key with a 32-bit width or less; nodes having a key with a 16-bit width or less; and nodes having a key only with an 8-bit width).

(1) Nodes having a key with a 32-bit width or less may include a key with a 32-bit width, and arbitrarily include a key with a 16-bit width and/or an 8-bit width. In the tree (201), the nodes having a key with a 32-bit width or less are root node (211) and the intermediate node (215). The root node (211) includes a key (70000) with a 32-bit width, a key (500) with a 16-bit width, and keys (0 and 50) with an 8-bit width. The intermediate node (215) only includes keys (70000, 71000 and 80000) with a 32-bit width.

(2) Nodes having a key with a 16-bit width or less may include a key with a 16-bit width, and arbitrarily include a key with an 8-bit width. In the tree (201), the nodes having a key with a 16-bit width or less are the intermediate node (213) and the intermediate node (214). The intermediate node (213) includes a key (400) with a 16-bit width, and a key (50) with an 8-bit width. The intermediate node (214) only includes keys (500 and 510) with a 16-bit width.

(3) In the tree (201), the nodes having a key only with an 8-bit width are the intermediate node (212) and the intermediate node (216). The intermediate node (212) only includes keys (0, 10 and 20) with an 8-bit width. The intermediate node (216) only includes keys (50 and 60) with an 8-bit width.

In the tree (201), the intermediate node (213) is a node having a key with a 16-bit width or less, and has the intermediate node (216) as a child node thereof. The intermediate node (216) is a node having a key only with an 8-bit width. That is, in the tree structure constructed for use for the search technique 1 according to the embodiment of the present invention, a certain intermediate node A may have, as a child node, an intermediate node B belonging to a group (i.e., a group having a key with a bit width smaller or larger than the bit width of a group to which the intermediate node A belongs) different from a group to which the intermediate node A belongs.

In the case of searching for data in the tree (201), data can be simultaneously compared using a SIMD instruction according to the key width (32-bit width, 16-bit width or 8-bit width) for each of (1) nodes having a key with a 32-bit width or less, (2) nodes having a key with a 16-bit width or less, and (3) nodes having a key only with an 8-bit width. Accordingly, the search speed is enhanced.

As described above, in the tree (201), a certain intermediate node A sometimes has, as a child node, an intermediate node B in a group different from the group to which the intermediate node A belongs. For instance, the intermediate node (213) having a key with a 16-bit width or less has, as a child node thereof, the intermediate node (216) having a key only with 8-bit width, which is different from the 16-bit width. Accordingly, during searching for data in the tree (201) using an instruction (e.g., a SIMD instruction) corresponding to a group having the minimum bit width where the value of a search key is an effective number, the computer is required to identify the type of the intermediate node (i.e., identify which type among the groups (1) to (3) the node belongs to) each time when traversing an intermediate node as a child node.

FIG. 3A is a diagram showing an example of a tree structure constructed for using for the search technique 2 according to an embodiment of the present invention. A tree (301) includes a root node (311), intermediate nodes (312 to 317), and leaf nodes (321 to 331). The root node (311) is a node at the top of the tree (301). Accordingly, the root node (311) has no parent node. The root node (311) can have multiple (four in the shown example) keys as entries. The root node (311) is connected to the intermediate nodes (312 to 317) directly or indirectly by edges. The entries of the root node (311) have the key values of the leftmost entries of the respective intermediate nodes (312, 313, and 314) connected to the root node (311) directly by edges.

The intermediate nodes (312 to 317) are nodes having child nodes, and other than the root node (311) and the leaf nodes (321 to 331). Each of the intermediate nodes (312 to 317) can have one or multiple (four in the shown example) keys as entries. The intermediate nodes (312 to 317) are connected to the root node (311) and the leaf nodes (321 to 331) directly or indirectly by edges. The intermediate node is also referred to as an internal node.

The leaf nodes (321 to 331) are nodes at the bottom of the tree (301). Accordingly, the leaf nodes (321 to 331) have no child node. Each of the leaf nodes (321 to 331) can have one or multiple (two in the shown example) keys as entries. The leaf nodes (321 to 331) store data.

The root node (311) and the intermediate nodes (312 to 317) are classified into nodes in the following four groups as groups having a minimum bit width capable of representing the value of a key:

(1) nodes having a key with a 32-bit width or less (i.e., can have a key with any bit width);
(2) nodes having a key only with a 32-bit width;
(3) nodes having a key only with a 16-bit width; and
(4) nodes having a key only with an 8-bit width.

The example of a tree (301) shown in FIG. 3A illustrates the case of classification into the nodes of four groups. Alternatively, classification into nodes of a different number of groups are allowed according to the minimum bit width capable of representing the value of a key, for instance, five groups (nodes having a key with a 64-bit width or less; nodes having a key only with a 64-bit width; nodes having a key only with a 32-bit width; nodes having a key only with a 16-bit width; and nodes having a key only with an 8-bit width), six groups (nodes having a key with a 128-bit width or less; nodes having a key only with a 128-bit width; nodes having a key only with a 64-bit width; nodes having a key only with a 32-bit width; nodes having a key only with a 16-bit width; and nodes having a key only with an 8-bit width), or seven groups (nodes having a key with a 256-bit width or less; nodes having a key only with a 256-bit width; nodes having a key only with a 128-bit width; nodes having a key only with a 64-bit width; nodes having a key only with a 32-bit width; nodes having a key only with a 16-bit width; and nodes having a key only with an 8-bit width).

(1) Nodes having a key with a 32-bit width or less may include a key with a 32-bit width, and arbitrarily include a key with a 16-bit width and/or an 8-bit width. In the tree (301), the node having a key with a 32-bit width or less is the root node (311). The root node (311) includes a key (70000) with a 32-bit width, a key (500) with a 16-bit width, and a key (0) with an 8-bit width.

(2) In the tree (301), the nodes having a key only with an 32-bit width are the intermediate node (314). The intermediate node (314) only includes keys (70000, 71000 and 80000) with a 32-bit width.

(3) In the tree (301), the nodes having a key only with a 16-bit width are the intermediate node (313), the intermediate node (316) and the intermediate node (317). The intermediate node (313) only includes keys (400 and 500) with a 16-bit width. The intermediate node (316) only includes a key (400) with a 16-bit width. The intermediate node (317) only includes keys (500 and 510) with a 16-bit width.

(4) In the tree (301), the nodes having a key only with an 8-bit width are the intermediate node (312) and the intermediate node (315). The intermediate node (312) only includes keys (0, 50 and 60) with an 8-bit width. The intermediate node (315) only includes keys (0, 10 and 20) with an 8-bit width.

In the tree structure constructed for use for the search technique 2 according to the embodiment of the present invention shown in FIG. 3A, the intermediate nodes, which are different from the root node, are classified into nodes only having a key with a 32-bit width, a 16-bit width, or an 8-bit width. In the tree structure constructed for use for the search technique 2 according to the embodiment of the present invention shown in FIG. 3A, a certain intermediate node A only has, as a child node, an intermediate node B in the group (i.e., a group having a key with the same bit width as the bit width of the group to which the intermediate node A belongs) identical to the group to which the intermediate node A belongs.

In the case of searching for data in the tree (301), data can be simultaneously compared using a SIMD instruction according to the key width (32-bit width, 16-bit width or 8-bit width) for each of (1) nodes having a key with a 32-bit width or less, (2) nodes having a key with a 16-bit width or less, and (3) nodes having a key only with an 8-bit width. Accordingly, the search speed is enhanced.

As described above, in the tree (301), it is secured that a certain intermediate node A other than the root node (311) has, as a child node, only the intermediate node B in the group (i.e., the group having a key with the same bit width as the bit width of the group to which the intermediate node A belongs) identical to the group to which the intermediate node A belongs. Accordingly, during searching for data in the tree (301) using an instruction (e.g., a SIMD instruction) corresponding to a group having the minimum bit width where the value of a search key is an effective number, only if the computer (101) determines the types of the intermediate nodes (312, 313 and 314) connected to the root node (311) directly by the edges (i.e., determines which type of the groups (2) to (4) the node belongs to), there is no need to determine the type of the intermediate node each time when traversing the intermediate node among the intermediate nodes as child nodes thereafter (i.e., determine which one of the groups (2) to (4) the node belongs to).

FIG. 3B is a diagram showing an example of a tree structure constructed for using for the search technique 2 according to the embodiment of the present invention. A tree (302) includes a root node (341), intermediate nodes (342 to 346), and leaf nodes (351 to 361). As to the root node (341), see description on the root node (311) with reference to FIG. 3A. As to the intermediate nodes (342 to 346), see description on the intermediate nodes (312 to 317) with reference to FIG. 3A. As to the leaf nodes (351 to 361), see description on the leaf nodes (321 to 331) with reference to FIG. 3A.

Unlike the root node (311) of the tree (301) shown in FIG. 3A, the root node (341) of the tree (302) shown in FIG. 3B are connected to multiple nodes having a key only with a certain bit width directly by edges. That is, the root node (341) is connected by edges directly to the intermediate node (343) and the intermediate node (344) that only have keys with a 16-bit width.

In the case of searching for data in the tree (302), data can be simultaneously compared using a SIMD instruction according to the key width (32-bit width, 16-bit width or 8-bit width) for each of (1) nodes having a key with a 32-bit width or less, (2) nodes having a key with a 16-bit width or less, and (3) nodes having a key only with an 8-bit width. Accordingly, the search speed is enhanced.

As described above, in the tree (302), it is secured that a certain intermediate node A other than the root node (341) only has, as a child node, the intermediate node B in the group (i.e., the group having a key with the same bit width as the bit width of the group to which the intermediate node A belongs) identical to the group to which the intermediate node A belongs. Accordingly, during search for data in the tree (302) using an instruction (e.g., a SIMD instruction) corresponding to a group having the minimum bit width where the value of a search key is an effective number, only if the computer (101) determines the types of the intermediate nodes (342, 343, 344 and 345) connected to the root node (341) directly by the edges (i.e., determines which type of the groups (2) to (4) the node belongs to), there is no need to determine the type of the intermediate node each time when traversing the intermediate node among the intermediate nodes as child nodes thereafter (i.e., determine which one of the groups (2) to (4) the node belongs to).

FIG. 3C is a diagram showing an example of a tree structure constructed for using for the search technique 2 according to the embodiment of the present invention.

The tree (303) includes nodes (371 to 374), and leaf nodes (381 to 391). The tree (303) does not include what is called a root node. However, it can be regarded that there substantially exists a root node as the top node with respect to the node (371), the node (372), and the node (373). Accordingly, the nodes (371 to 374) correspond to intermediate nodes. Alternatively, the tree (303) can be regarded as a tree adopting the top nodes that are the node (371), the node (372) and the node (373) as the respective root nodes of partial trees. In this case, the intermediate node with respect to the root node (371) is the node (374).

As to the root node and the intermediate nodes, see the description on the root node (311) and the intermediate nodes (312 to 317) with respect to FIG. 3A. As to the leaf nodes (381 to 391), see description on the leaf nodes (321 to 331) with reference to FIG. 3A.

The nodes (371 to 374) are classified into nodes in the following three groups as groups having a minimum bit width capable of representing the value of a key:

(1) nodes having a key only with a 32-bit width;
(2) nodes having a key only with a 16-bit width; and
(3) nodes having a key only with an 8-bit width.

The example of a tree (303) shown in FIG. 3C has illustrated the case of classification into nodes of three groups. Alternatively, classification into nodes of a different number of groups are allowed according to the minimum bit width capable of representing the value of a key, for instance, four groups (nodes having a key only with a 64-bit width; nodes having a key only with a 32-bit width; nodes having a key only with a 16-bit width; and nodes having a key only with an 8-bit width), five groups (nodes having a key only with a 128-bit width; nodes having a key only with a 64-bit width; nodes having a key only with a 32-bit width; nodes having a key only with a 16-bit width; and nodes having a key only with an 8-bit width), or six groups (nodes having a key only with a 256-bit width; nodes having a key only with a 128-bit width; nodes having a key only with a 64-bit width; nodes having a key only with a 32-bit width; nodes having a key only with a 16-bit width; and nodes having a key only with an 8-bit width).

(1) In the tree (303), the nodes having a key only with a 32-bit width are the node (373). The node (373) only includes keys (70000, 71000 and 80000) with a 32-bit width. Accordingly, the node (373) and the leaf nodes (389 to 391) are a partial tree of the tree (303). The partial tree can be regarded as a group only having keys with a 32-bit width. In this case, the node (373) can be regarded as the root node of the partial tree.

(2) In the tree (303), the nodes having a key only with a 16-bit width are the node (372). The node (372) only includes keys (400, 500 and 510) with a 16-bit width. Accordingly, the node (372) and the leaf nodes (386 to 388) form a partial tree of the tree (303). The partial tree can be regarded as a group only having keys with a 16-bit width. In this case, the node (372) can be regarded as the root node of the partial tree.

(3) In the tree (303), the nodes having a key only with an 8-bit width are the node (371) and the node (374). The node (371) only includes keys (0, 50 and 60) with an 8-bit width. The node (374) only includes keys (0, 10 and 20) with an 8-bit width. Accordingly, the node (371), the node (374) and the leaf nodes (381 to 385) form a partial tree of the tree (303). The partial tree can be regarded as a group only having keys with an 8-bit width. In this case, it can be regarded that the node (371) is the root node of the partial tree, and the node (374) is an intermediate tree.

In the tree structure constructed for use for the search technique 2 according to the embodiment of the present invention shown in FIG. 3C, the nodes are classified into nodes having a key only with a 32-bit width, a 16-bit width, or an 8-bit width. In the tree structures constructed for use for the search technique 2 according to the embodiment of the present invention shown in FIG. 3C, a certain intermediate node A only has, as a child node, an intermediate node B in the group (i.e., a group having a key with the same bit width as the bit width of the group to which the intermediate node A belongs) identical to the group to which the intermediate node A belongs.

In the case of searching the tree (303) for data, data can be simultaneously compared using a SIMD instruction according to the key width (32-bit width, 16-bit width or 8-bit width) for each of (1) nodes having a key with a 32-bit width or less, (2) nodes having a key with a 16-bit width or less, and (3) nodes having a key only with an 8-bit width. Accordingly, the search speed is enhanced.

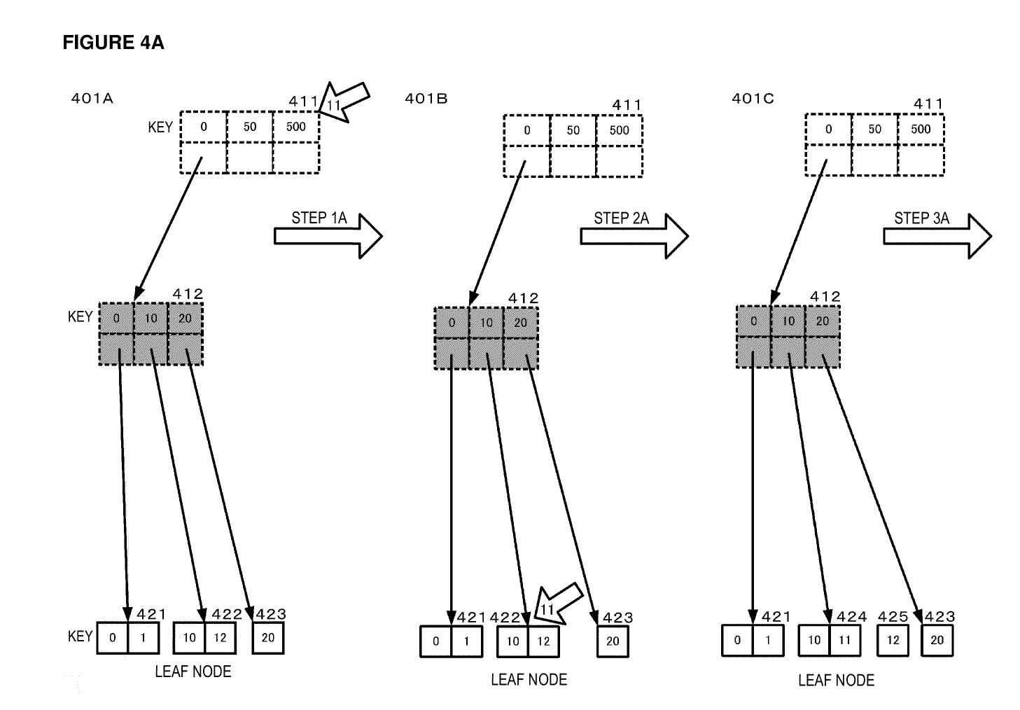

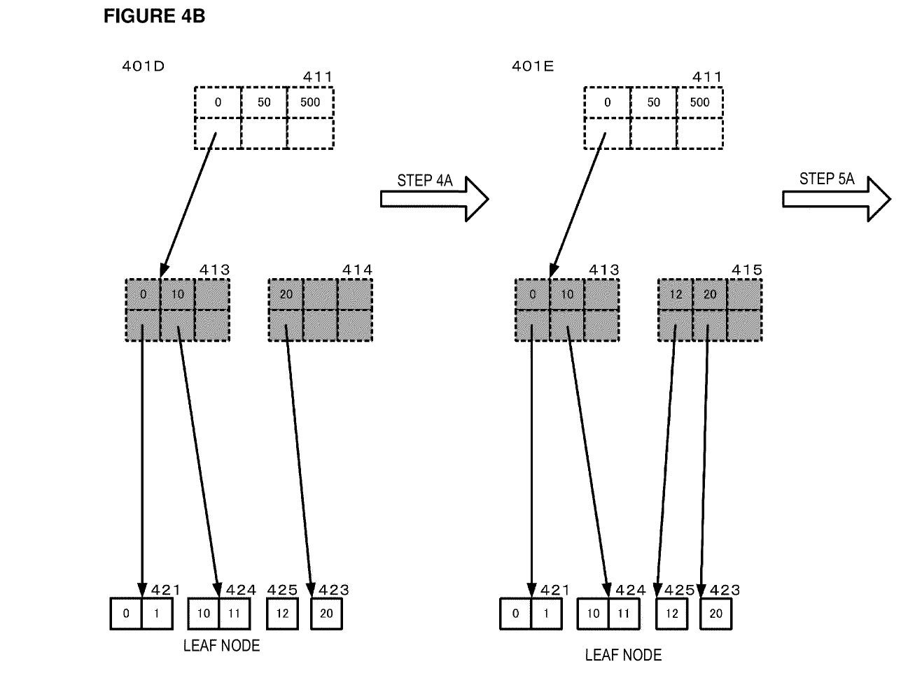

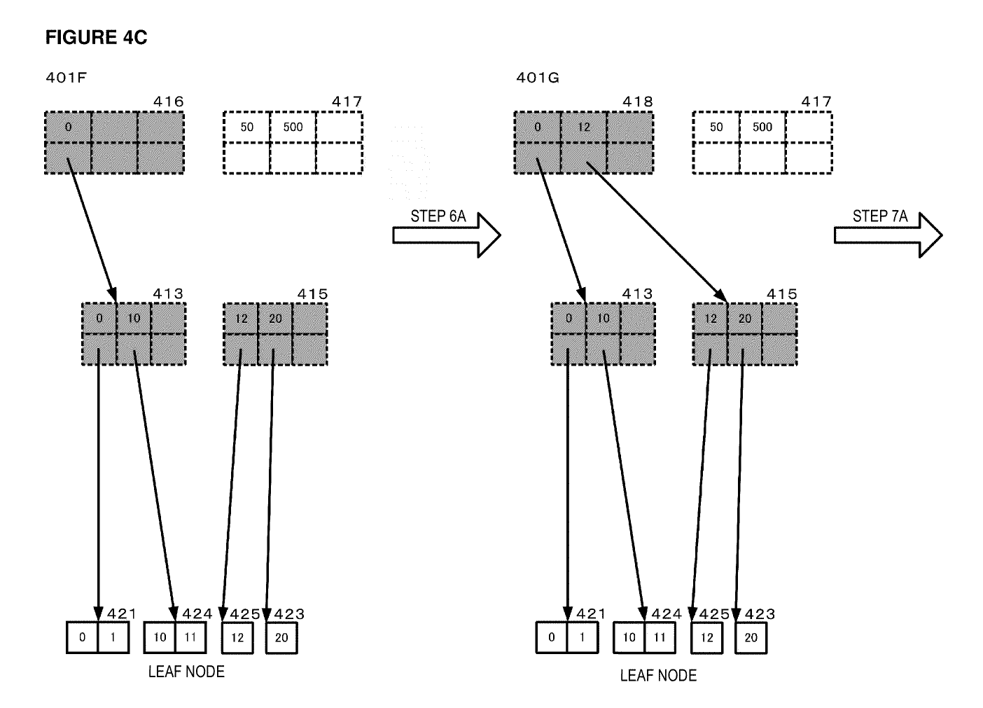

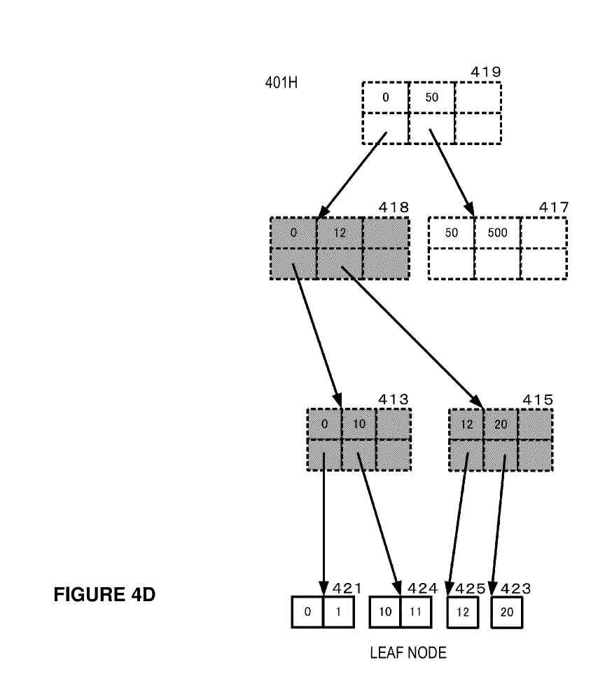

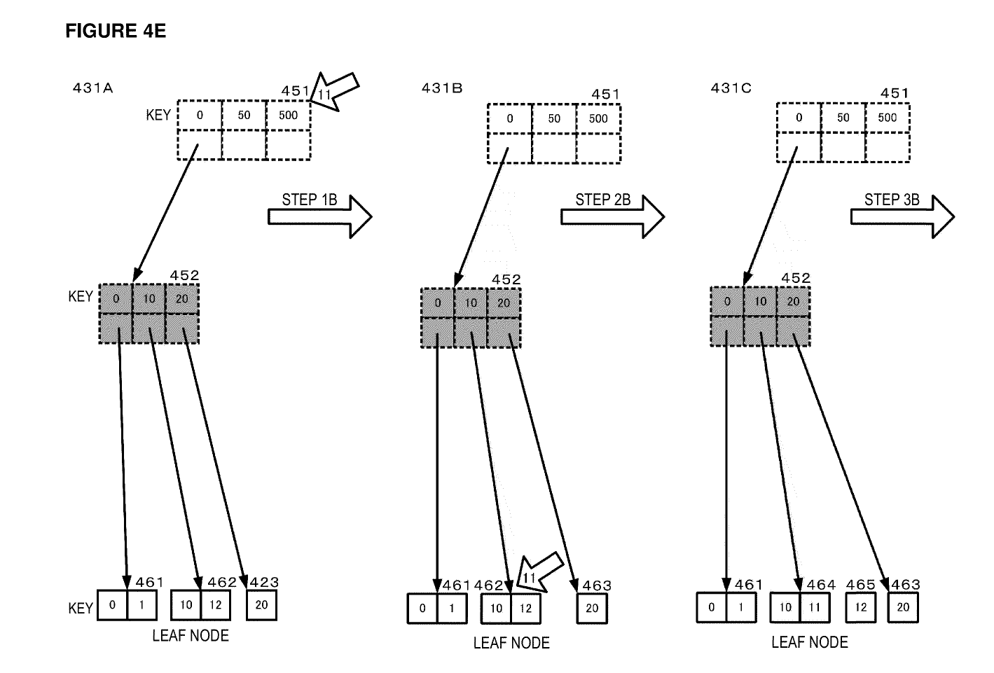

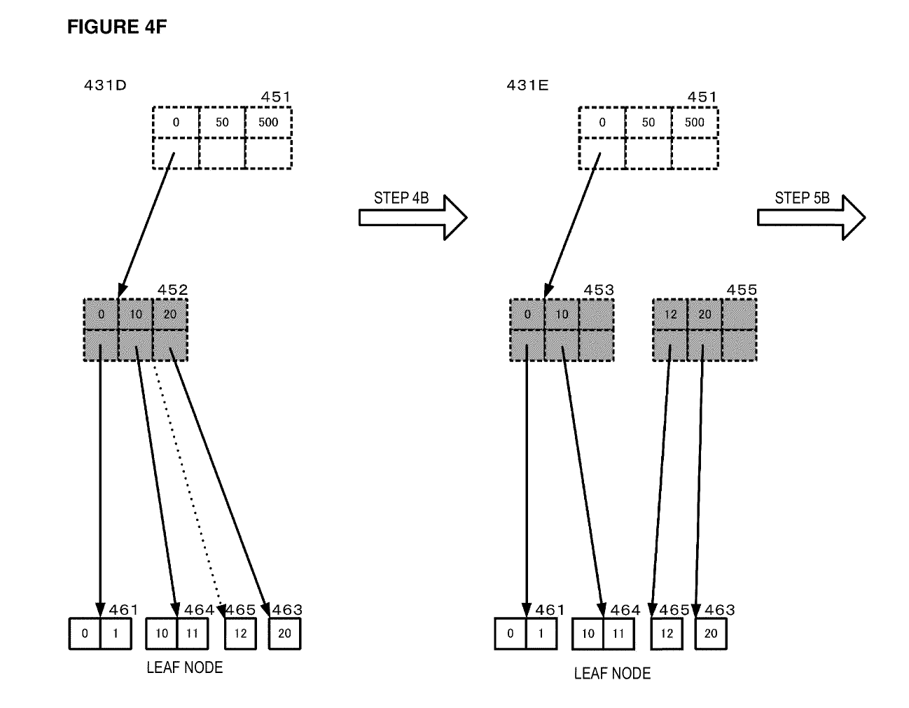

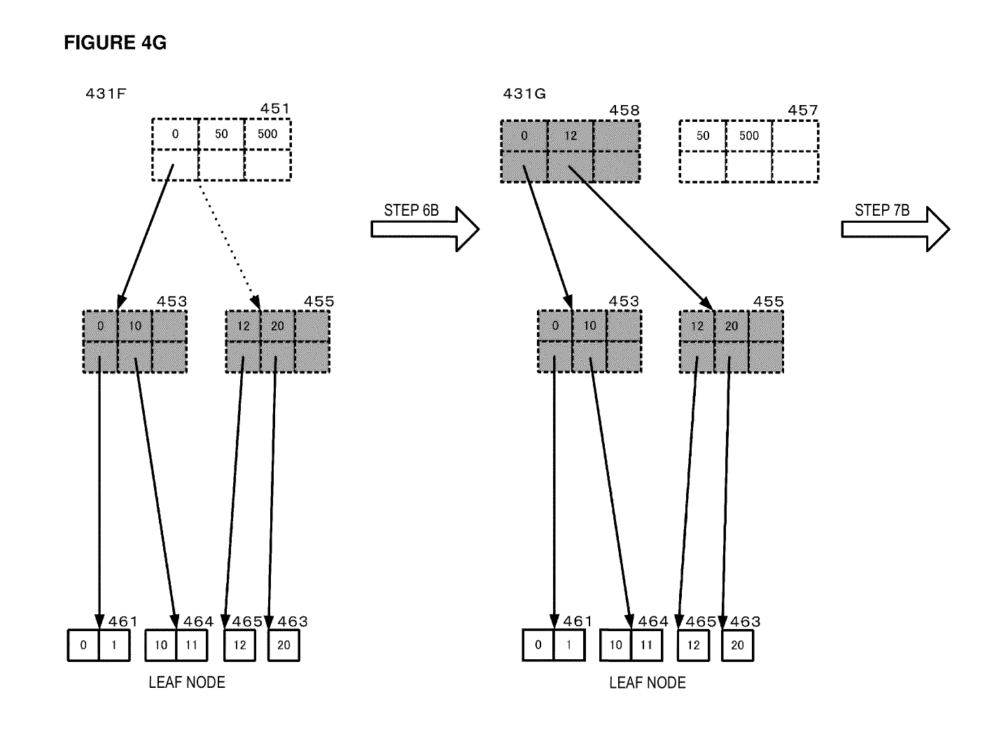

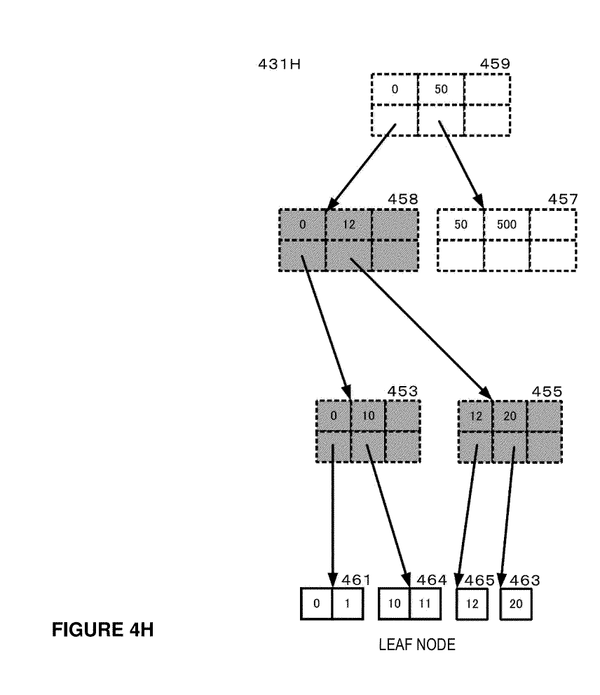

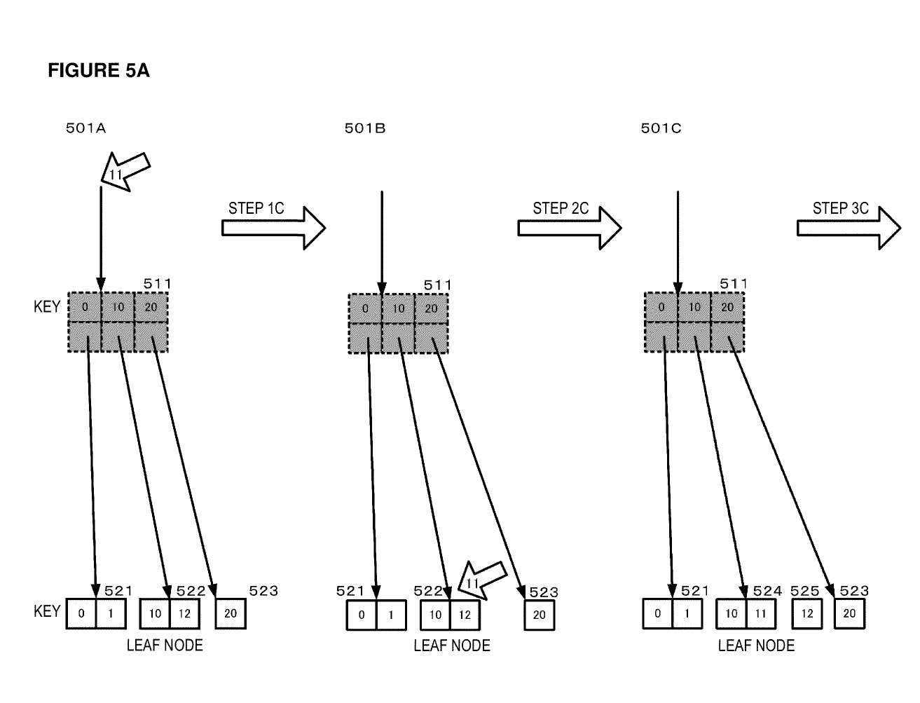

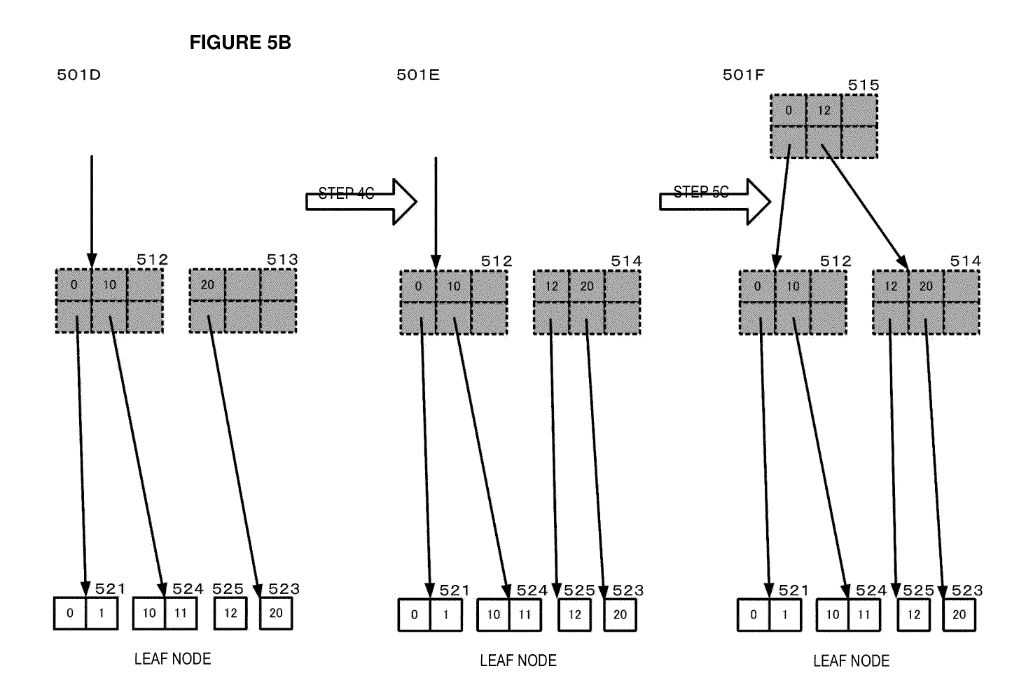

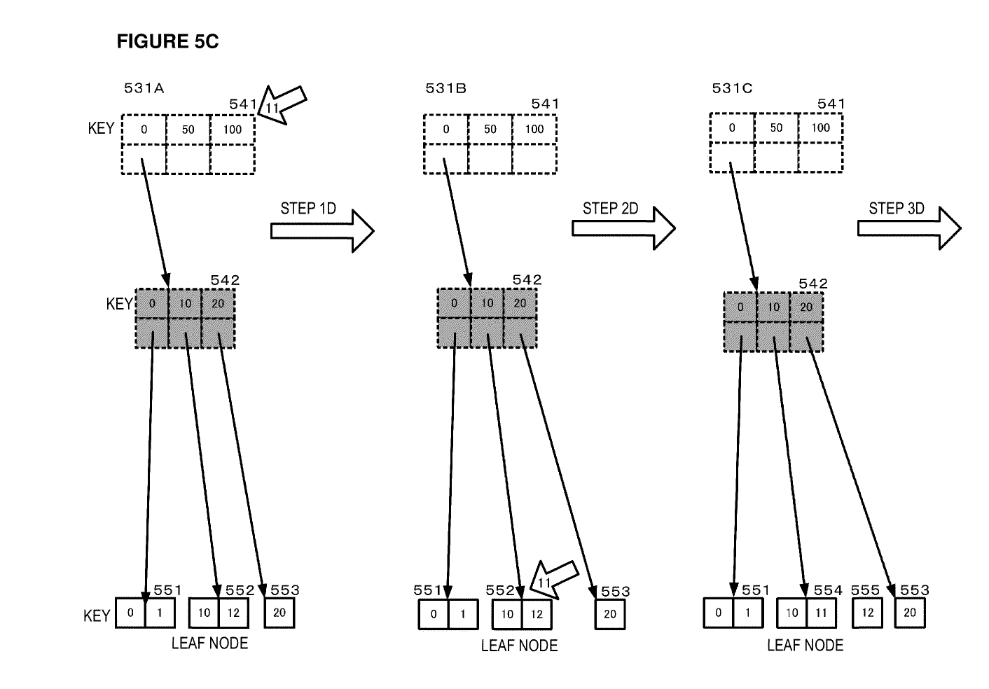

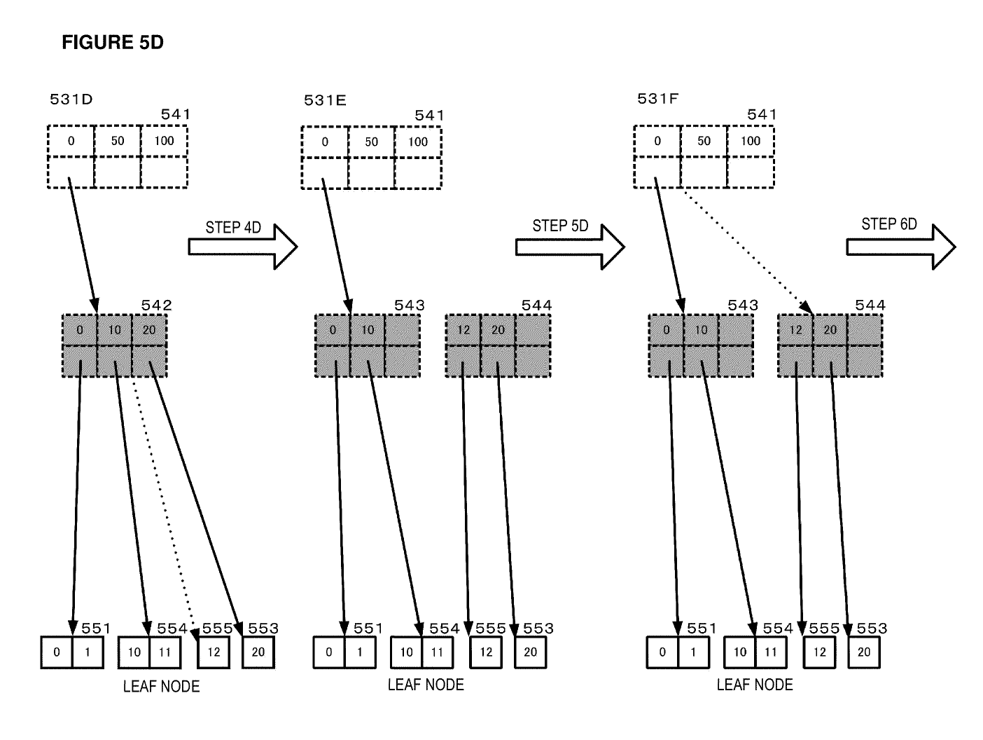

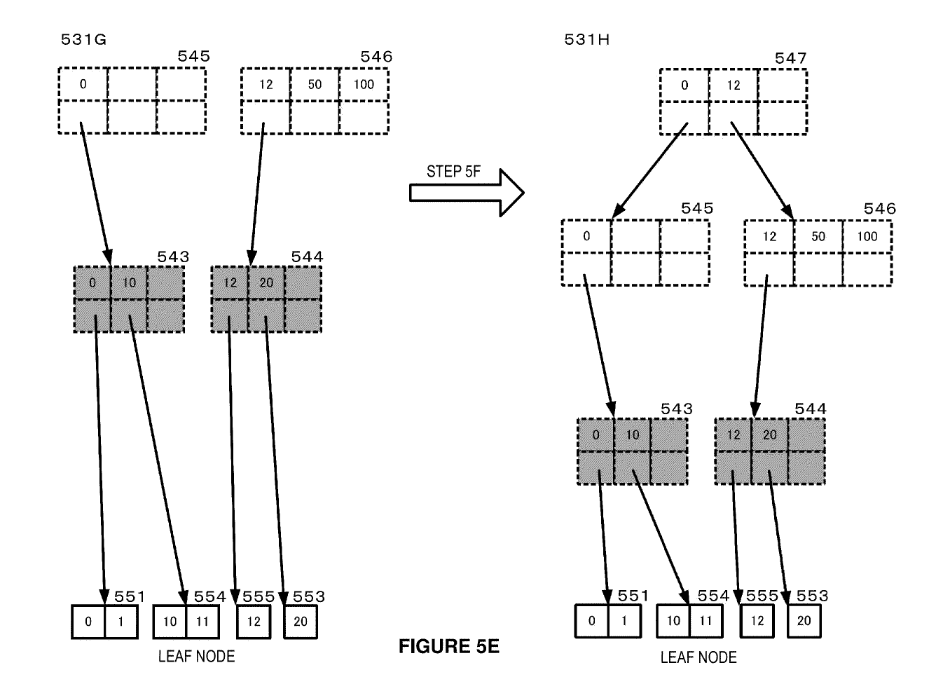

As described above, in the tree (303), it is secured that a certain node A has, as a child node, only the node B in the group (i.e., the group having a key with the same bit width as the bit width of the group to which the node A belongs) identical to the group to which the node A belongs. Accordingly, during searching for data in the tree (303) using an instruction (e.g., a SIMD instruction) corresponding to a group having the minimum bit width where the value of a search key is an effective number, only if the computer (101) identifies the types of the top nodes (371, 372 and 373) (i.e., identifies which type of the groups (1) to (3) the node belongs to), there is no need to determine the type of the child node each time when traversing the child node among the child nodes thereafter (i.e., determine which one of the groups (1) to (3) the node belongs to). The following FIGS. 4A to 4D and FIGS. 4E to 4H show Examples 1 and 2 for dynamically reconstructing a tree by inserting an entry into a node of a tree in a tree structure constructed for use for the search technique 1. Likewise, the following FIGS. 5A and 5B and FIGS. 5C to 5E show Examples 1 and 2 for dynamically reconstructing a tree by inserting an entry into a node of a tree in a tree structure constructed for use for the search technique 2.

FIGS. 4A to 4D are diagrams showing Example 1 for dynamically reconstructing the tree by inserting an entry into a node of the tree in the tree structure constructed for use for the search technique 1 according to an embodiment of the present invention. The tree (401A) to be reconstructed is a partial tree, and includes a root node (not shown), intermediate nodes (411 and 412), and leaf nodes (421 to 423). Each of the intermediate nodes (411 and 412) can have three keys at most, and each of the leaf nodes (421 to 423) can have two keys at most. The intermediate node (411) is a node having a key with a 16-bit width or less, i.e., includes a key (500) with a 16-bit width, and keys (0 and 50) with an 8-bit width. The intermediate node (412) is a node only having keys with an 8-bit width, i.e., only includes keys (0, 10 and 20) with an 8-bit width. The computer (101) tries to insert an entry (key value of 11) having a key value of 11 into a leaf node in the tree (401A).

As shown at block 1A, the computer (101) performs an operation for finding a leaf node where the key value of 11 is to be inserted in the tree (401A). Since the key value of 11 is smaller than the key value of 50 in the intermediate node (411), the computer (101) finds the intermediate node (412) indicated by the entry left to the key value of 50 in the intermediate node (411). Subsequently, since the key value of 11 is smaller than the key value of 20 in the found intermediate node (412) in the tree (401B; same as 401A), the computer (101) finds the leaf node (422) indicated by the entry left to the key value of 20 in the intermediate node (412).

As shown at block 2A, the computer (101) tries to insert the key value of 11 into the leaf node (422) found in the block 1A (see the tree (401B) shown in FIG. 4A). However, since the leaf node (422) already has two key values of 10 and 12, and the leaf node can only have two keys at most, the computer (101) determines that insertion of the key value of 11 into the leaf node (422) causes entries of the leaf node (422) to overflow. Thus, the computer (101) divides the leaf node (422) into two leaf nodes, i.e., a leaf node with a key value of 10 and a leaf node (425) with a key value of 12 (see the tree (401C) shown in FIG. 4A). The computer (101) inserts the key value of 11 into the leaf node that has been divided and has the key value of 10 to generate the leaf node (424) with key values of 10 and 11 (see the tree (401C) shown in FIG. 4A).

As shown at block 3A, since there is no edge from the parent intermediate node (412) to the leaf node (425) with the key value of 12 in the tree (401C), the computer (101) creates a link from the intermediate node (412) to the leaf node (425). The computer (101) thus tries to insert the key value of 12 into the intermediate node (412). However, since the intermediate node (412) already has three key values of 0, 10 and 12 and the intermediate node can only have three keys at most, the computer (101) determines that insertion of the key value of 12 into the intermediate node (412) causes the entries of the intermediate node (412) to overflow. The computer (101) then divides the intermediate node (412) into two intermediate nodes, i.e., an intermediate node (413) and an intermediate node (414) (see the tree (401D) shown in FIG. 4B). The intermediate node (413) has keys with an 8-bit width, which is the same as the keys before division, and thus has key values of 0 and 10 (see the tree (401D) shown in FIG. 4B). The intermediate node (414) has a key with an 8-bit width, which is the same as the key before division, and has a key value of 20 (see the tree (401D) shown in FIG. 4B).

As shown at block 4A, the computer (101) inserts the key value of 12 at the left end of the divided intermediate node (414) in the tree (401D) to create an intermediate node (415) with the key values of 12 and 20 (see the tree (401E) shown in FIG. 4B). Alternatively, the computer (101) may insert the key value of 12 at the right end of the divided intermediate node (413) to create an intermediate node with key values of 0, 10 and 12 (not shown). Subsequently, a mode is hereinafter described that creates the intermediate node with key values of 12 and 20 (415). Since there is no edge from the parent intermediate nodes (413 and 415) to the leaf node (425) with the key value of 12, the computer (101) then creates a link from the intermediate node (415) to the leaf node (425) with the key value of 12 (see tree (401E) shown in FIG. 4B).

As shown at block 5A, since there is no edge from the parent intermediate node (411) to the intermediate node (415) in the (401E), the computer (101) creates a link from the intermediate node (411) to the intermediate node (415). Thus the computer (101) tries to insert the key value of 12 into the intermediate node (411). However, since the intermediate node (411) already has three key values of 0, 50 and 500 and the intermediate node can only have three keys at most, the computer (101) determines that insertion of the key value of 12 into the intermediate node (411) causes the entries in the intermediate node (411) to overflow. The computer (101) then divides the intermediate node (411) into two intermediate nodes, i.e., an intermediate node (416) and an intermediate node (417) (see the tree (401F) shown in FIG. 4C). The intermediate node (416) only has a key with an 8-bit width, which is different from the key with a 16-bit width or less before division, and has a key value of 0 (see the tree (401F) shown in FIG. 4C). The reason why the intermediate node (416) has a key only with an 8-bit width of a group, which is different from that of the key of a 16-bit width or less before division is that the key value of 0 of the intermediate node (416) can be represented only by an 8-bit width. Accordingly, the group of the intermediate node (416) is changed from the group of the node having a key with a 16-bit width or less to the group of the node having a key only with an 8-bit width. The intermediate node (417) has a key with a 16-bit width or less, which is the same as the key with a 16-bit width or less before division, and has key values of 50 and 500 (see tree (401F) shown in FIG. 4C).

As shown at block 6A, the computer (101) inserts the key value of 12 into the divided intermediate node (416) in the tree (401F) to create an intermediate node (418) (see the tree (418) shown in FIG. 4C). Since there is no edge from the parent intermediate node (418) to the intermediate node (415) with the key value of 12, the computer (101) then creates a link from the intermediate node (418) to the intermediate node (415) with the key value of 12 (see tree (401G) shown in FIG. 4C).

As shown at block 7A, the computer (101) creates a parent node (419) of the intermediate node (418) and the intermediate node (417) in the tree (401G) (see the tree (401H) shown in FIG. 4D). The parent node (419) is a node having a key with a 16-bit width or less, has the key value of 0 that is at the left end of the intermediate node (418) and the key value of 50 that is at the left end of the intermediate node (417).

The tree (401H) shown in FIG. 4D is a tree dynamically reconstructed from the tree (401A) to be reconstructed shown in FIG. 4A. As described in the foregoing Example 1 with reference to FIGS. 4A to 4D, insertion of the entry with the key value of 11 (key value of 11) into the node of tree (401A) divides the intermediate node and the leaf node, and dynamically reconstructs the new tree (401H) that is to be used in the search technique 1.

FIGS. 4E to 4H are diagrams showing Example 2 for dynamically reconstructing a tree by inserting an entry into a node of a tree in a tree structure constructed for use for the search technique 1 according to an embodiment of the present invention. A tree (431A) to be reconstructed is the same as the tree (401A) shown in FIG. 4A. Accordingly, as to description on the tree (431A) to be reconstructed and an intermediate node (451) and an intermediate node (452), see the description on the tree (401A) to be reconstructed and the intermediate node (411) and the intermediate node (412) that are shown in FIG. 4A.

The computer (101) tries to insert an entry (key value of 11) having a key value of 11 into a leaf node in the tree (431A). Blocks 1B and 2B correspond to the respective blocks 1A and 2A shown in FIG. 4A. Accordingly, as to description on blocks 1B and 2B, see the description on the respective blocks 1A and 2A shown in FIG. 4.

As shown at block 3B, since there is no edge from the parent intermediate node (452) to a leaf node (465) with the key value of 12 in the tree (431C), the computer (101) creates a link from the intermediate node (452) to the leaf node (465) (see the dotted line in the tree (431D) shown in the following FIG. 4F).

As shown at block 4B, the computer (101) tries to insert the key value of 12 into the intermediate node (452). However, since the intermediate node (452) already has three key values of 0, 10 and 20 and the intermediate node can only have three keys at most, the computer (101) determines that insertion of the key value of 12 in the intermediate node (452) causes the entries of the intermediate node (452) to overflow. Thus, the computer (101) divides the intermediate node (452) into two intermediate nodes, i.e., an intermediate node (453) and an intermediate node (455) (see the tree (431E) shown in FIG. 4F). The intermediate node (453) has keys with an 8-bit width, which is the same as the keys before division, and has key values of 0 and 10 (see the tree (431E) shown in FIG. 4F). The intermediate node (455) has keys with an 8-bit width, which is the same as the keys before division, and has a key value of 12 (inserted) and a key value of 20 (see the tree (431E) shown in FIG. 4F). Alternatively, the computer (101) may insert the key value of 12 at the right end of the divided intermediate node (453) to create an intermediate node with key values of 0, 10 and 12 (not shown). Subsequently, a mode is hereinafter described that creates the intermediate node (455) with key values of 12 and 20.

As shown at block 5B, since there is no edge from the parent intermediate node (451) to the intermediate node (455) in the tree (431E), the computer (101) creates a link from the intermediate node (451) to the intermediate node (455). (See the dotted line in the tree (431F) shown in FIG. 4G).

As shown at block 6B, the computer (101) tries to insert a key value of 12 into the intermediate node (451). However, since the intermediate node (451) already has three key values of 0, 50 and 500 and the intermediate node can only have three keys at most, the computer (101) determines that insertion of the key value of 12 into the intermediate node (451) causes the entries in the intermediate node (451) to overflow. Thus, the computer (101) divides the intermediate node (451) into two intermediate nodes, i.e., an intermediate node (458) and an intermediate node (457) (see the tree (431G) shown in FIG. 4G). The intermediate node (458) only has keys with an 8-bit width, which are different from keys with a 16-bit width or less before division, and has key values of 0 and 12 (inserted) (see tree (431G) shown in FIG. 4G). The reason why the intermediate node (458) only has the keys with an 8-bit width of a group, which is different from that of the key of a 16-bit width or less before division is that the key value of 0 of the intermediate node (458) can be represented only by an 8-bit width. Accordingly, the group of the intermediate node (458) is changed from the group of the node having a key with a 16-bit width or less to the group of the node having a key only with an 8-bit width. The intermediate node (457) has a key with a 16-bit width or less, which is the same as the key with a 16-bit width or less before division, and has key values of 50 and 500 (see tree (431G) shown in FIG. 4G).

As shown at block 7B, the computer (101) creates a parent node (459) of the intermediate node (458) and the intermediate node (457) (see the tree (431H) in FIG. 4H). The parent node (459) is a node having keys with a 16-bit width or less, has the key value of 0 that is at the left end of the intermediate node (458) and the key value of 50 that is at the left end of the intermediate node (457). The tree (431H) shown in FIG. 4H is a tree dynamically reconstructed from the tree (431A) that is to be reconstructed shown in FIG. 4E.

As described in the foregoing Example 2 with reference to FIGS. 4E to 4H, insertion of the entry with the key value of 11 (key value of 11) into the node of tree (431A) divides the intermediate node and the leaf node, and dynamically reconstructs the new tree (431H) that is to be used in the search technique 1.

FIGS. 5A and 5D are diagrams showing Example 1 for dynamically reconstructing a tree by inserting an entry into a node of the tree in a tree structure constructed for use for the search technique 2 according to an embodiment of the present invention. The tree (501A) to be reconstructed is a partial tree, and includes a root node of the partial tree (which is not shown and is also an intermediate node from a viewpoint of the entire tree), the intermediate node (511) and the leaf nodes (521 to 523). The intermediate node (511) can have three keys at most, and the leaf nodes (521 to 523) can have two keys at most. The intermediate node (511) only includes keys (0, 10 and 20) with an 8-bit width. The computer (101) tries to insert an entry (key value of 11) having a key value of 11 into a leaf node in the tree (501A).

As shown at block 1C, the computer (101) performs an operation for finding a leaf node where the key value of 11 is to be inserted into the tree (501A). Since the key value of 11 is smaller than the key value of 20 in the intermediate node (511), the computer (101) finds the leaf node (522) indicated by the entry left to the key value of 20 in the intermediate node (511).

As shown at block 2C, the computer (101) tries to insert the key value of 11 into the leaf node (522) found in the block 1C (see the tree (501B) shown in FIG. 5A) in the tree (501B; same as 501A). However, since the leaf node (522) already has two key values of 10 and 12, and the leaf node can only have two key values at most, the computer (101) determines that insertion of the key value of 11 into the leaf node (522) causes entries of the leaf nodes (522) to overflow. Thus, the computer (101) divides the leaf node (522) into two leaf nodes, i.e., a leaf node with a key value of 10 (not shown) and a leaf node (525) with a key value of 12 (see the tree (501C) shown in FIG. 5A). The computer (101) inserts the key value of 11 into the leaf node that has been divided and has the key value of 10 (not shown) to generate a leaf node (524) with key values of 10 and 11 (see the tree (501C) shown in FIG. 5A).

As shown at block 3C, since there is no edge from the parent intermediate node (511) to the leaf node (525) with the key value of 12, the computer (101) creates a link from the intermediate node (511) to the leaf node (525). Thus the computer (101) tries to insert a key value of 12 into the intermediate node (511). However, since the intermediate node (511) already has three key values of 0, 10 and 20 and the intermediate node can only have three keys at most, the computer (101) determines that insertion of the key value of 12 into the intermediate node (511) causes the entries of the intermediate node (511) to overflow. Thus, the computer (101) divides the intermediate node (511) into two intermediate nodes, i.e., an intermediate node (512) and an intermediate node (513) (see the tree (501D) shown in FIG. 5B). The intermediate node (512) has keys only with an 8-bit width, which is the same as the keys before division, and has key values of 0 and 10 (see the tree (501D) shown in FIG. 5B). The intermediate node (513) has keys only with an 8-bit width, which is the same as the keys before division, and has a key value of 20 (see the tree (501D) shown in FIG. 5B).

As shown at block 4C, the computer (101) inserts a key value of 12 at the left end of the divided intermediate node (513) to create an intermediate node (514) with the key values of 12 and 20 (see the tree (501E) shown in FIG. 5B). Alternatively, the computer (101) may insert a key value of 12 at the right end of the divided intermediate node (512) to create an intermediate node with key values of 0, 10 and 12. Subsequently, a mode is hereinafter described that creates the intermediate node (514) with key values of 12 and 20. Since there is no edge from the parent intermediate nodes (512 and 513) to the leaf node (525) with the key value of 12, the computer (101) then creates a link from the intermediate node (514) to the leaf node (525) with the key value of 12 (see tree (501E) shown in FIG. 5B).

As shown at block 5C, the computer (101) creates a parent node (515) of the intermediate node (512) and the intermediate node (514) (see the tree (501F) shown in FIG. 5B). The parent node (515) is a node having a key only with an 8-bit width, and has the key value of 0 that is at the left end of the intermediate node (512) and the key value of 12 that is at the left end of the intermediate node (514).

The tree (501F) shown in FIG. 5B is a tree dynamically reconstructed from the tree (501A) that is to be reconstructed shown in FIG. 5A. As described in the foregoing Example 1 with reference to FIGS. 5A and 5B, insertion of the entry with the key value of 11 (key value of 11) into the node of tree (501A) divides the intermediate node and the leaf node, and dynamically reconstructs the new tree (501F) that is to be used in the search technique 2. FIGS. 5C to 5E are diagrams showing Example 1 for dynamically reconstructing a tree by inserting an entry into a node of the tree in a tree structure constructed for use for the search technique 2 according to an embodiment of the present invention.

The tree (531A) to be reconstructed is a partial tree, and includes a root node of the partial tree (541; which is also an intermediate node from a viewpoint of the entire tree), an intermediate node (542), and leaf nodes (551 to 553). The root node (541) and the intermediate node (542) can have three keys at most, and the leaf nodes (551 to 553) can have two keys at most.

The node (541) only includes keys (0, 50 and 100) with an 8-bit width. The intermediate node (542) only includes keys (0, 10 and 20) with an 8-bit width. The computer (101) tries to insert an entry (key value of 11) having a key value of 11 into the leaf node in the tree (531A). As shown at block 1D, the computer (101) performs an operation for finding a leaf node where the key value of 11 is to be inserted into the tree (531A). Since the key value of 11 is smaller than the key value of 50 in the root node (541), the computer (101) finds the intermediate node (542) indicated by the entry left to the key value of 50 in the root node (541). Subsequently, since the key value of 11 is smaller than the key value of 20 in the found intermediate node (512), the computer (101) finds the leaf node (552) indicated by the left entry with a key value of 20 in the intermediate node (542).

As shown at block 2D, the computer (101) tries to insert a key value of 11 into the leaf node (552) found in the block 1D (see the tree (531B) shown in FIG. 5C) in the tree (531B; which is the same as 531A). However, since the leaf node (552) already has two key values of 10 and 12 and the leaf node can only have two keys at most, the computer (101) determines that insertion of the key value of 11 into the leaf node (552) causes entries of the leaf node (552) to overflow. Thus, the computer (101) divides the leaf node (552) into two leaf nodes, i.e., a leaf node with a key value of 10 (not shown) and a leaf node (555) with a key value of 12 (see the tree (531C) shown in FIG. 5C). The computer (101) inserts the key value of 11 into the leaf node that has been divided and has the key value of 10 (not shown) to generate a leaf node (554) with key values of 10 and 11 (see the tree (501C) shown in FIG. 5C).

As shown at block 3D, since there is no edge from the parent intermediate node (541) to the leaf node (555) with the key value of 12, the computer (101) creates a link from the intermediate node (542) to the leaf node (555) (see the dotted line in the tree (531D) show in the following FIG. 5D).

As shown at block 4D, the computer (101) tries to insert the key value of 12 into the intermediate node (542). However, since the intermediate node (542) already has three key values of 0, 10 and 20 and the intermediate node can only have three keys at most, the computer (101) determines that insertion of the key value of 12 into the intermediate node (542) causes the entries of the intermediate node (542) to overflow. Thus, the computer (101) divides the intermediate node (542) into two intermediate nodes, i.e., an intermediate node (543) and an intermediate node (544) (see the tree (531E) shown in FIG. 5D). The intermediate node (543) has keys with an 8-bit width, which is the same as the keys before division, and has key values of 0 and 10 (see the tree (531E) shown in FIG. 5D). The intermediate node (544) has keys with an 8-bit width, which is the same as the keys before division, and has a key value of 12 (inserted) and a key value of 20 (see the tree (531E) shown in FIG. 5D). Alternatively, the computer (101) may insert the key value of 12 at the right end of the divided intermediate node (543) to create an intermediate node with key values of 0, 10 and 12 (not shown). Subsequently, a mode is hereinafter described that creates the intermediate node (544) with key values of 12 and 20.

As shown at block 5D, since there is no edge from the parent root node (541) to the intermediate node (544) in the tree (531E), the computer (101) creates a link from the root node (541) to the intermediate node (544) (see the dotted line shown in the tree (531F) in FIG. 5D).

As shown at block 6D, the computer (101) tries to insert the key value of 12 into the root node (541). However, since the root node (541) already has three key values of 0, 50 and 100 and the root node can only have three keys at most, the computer (101) determines that insertion of the key value of 12 into the root node (541) causes entries of the root node (541) to overflow. Thus, the computer (101) divides the root node (541) into two intermediate nodes, i.e., an intermediate node (545) and an intermediate node (546) (see the tree (531G) shown in the following FIG. 5E). The intermediate node (545) only has a key with an 8-bit width, which is the same as that before division, and has a key value of 0 (see the tree (531G) shown in FIG. 5E). The intermediate node (546) only has keys with an 8-bit width, which is the same as that before division, and has key values of 12 (inserted), 50 and 100 (see the tree (531G) shown in FIG. 5E).

As shown at block 7D, the computer (101) creates a parent node (547) of the intermediate node (545) and the intermediate node (546) (see the tree 531H in FIG. 5E). The parent node (547) is a node having a key only with an 8-bit width as with the intermediate node (545) and the intermediate node (546), and has the key value of 0 that is at the left end of the intermediate node (545) and the key value of 12 that is at the left end of the intermediate node (546). The tree (531H) shown in FIG. 5H is a tree dynamically reconstructed from the tree (531A) that is to be reconstructed shown in FIG. 5C.

As described in the foregoing Example 2 with reference to FIGS. 5C to 5E, insertion of the entry with the key value of 11 (key value of 11) into the node of tree (531A) divides the intermediate node and the leaf node, and dynamically reconstructs the new tree (531H) that is to be used in the search technique 2.

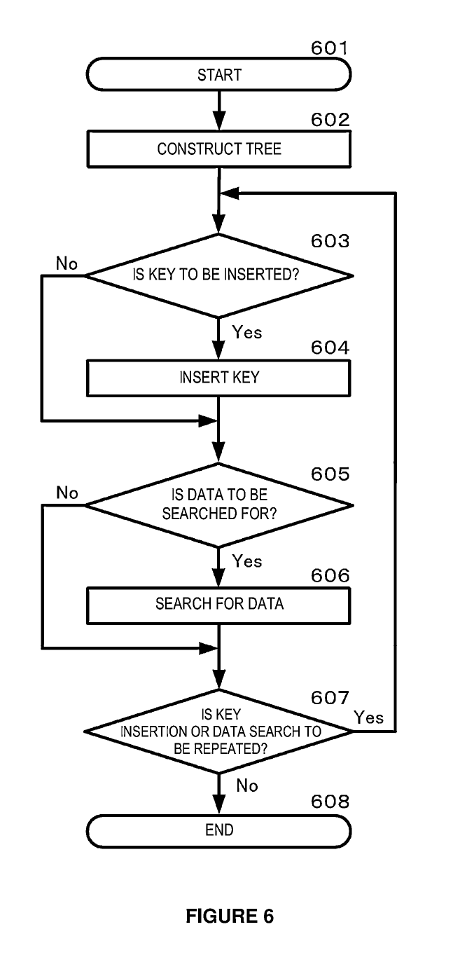

FIG. 6 shows a flowchart of entire processes of searching a tree using an instruction of operating data having predetermined multiple bit widths according to an embodiment of the present invention. As shown at block 601, the computer (101) starts a process of searching a tree using an instruction of operating data having predetermined multiple bit widths.

As shown at block 602, the computer (101) constructs a tree structure for use for the search technique 1 or 2 according to an embodiment of the present invention. In construction of the tree structure, the computer (101) classifies multiple bit widths into groups with the minimum bit width capable of representing a key value, and constructs the tree. The groups may be, for instance, nodes only having a key with an 8-bit width, nodes only having a key with a 16-bit width or less, nodes only having a 32-bit width or less, nodes only having a key with a 64-bit width or less, nodes only having a key with a 128-bit width or less, or nodes only having a key with a 256-bit width or less.

In the case of constructing a tree structure for use for the search technique 1 according to the embodiment of the present invention, the computer (101) can construct a tree such that nodes (e.g., intermediate nodes) other than the root node of the tree have the minimum bit width capable of representing a key value among multiple bit widths.

In the case of constructing a tree structure for use for the search technique 1 according to the embodiment of the present invention, the computer (101) can construct the tree such that the root node of the tree has, as child nodes, at least two groups with the minimum bit width capable of representing a key value among multiple bit widths.

In the case of constructing a tree structure for use for the search technique 1 according to the embodiment of the present invention, the computer (101) can assign identifiers capable of identifying the groups (i.e., node ID=08 (a node having a key only with an 8-bit width), 16 (a node having a key only with a 16-bit width), and 32 (a node having a key only with a 32-bit width)) to each of nodes (the root node and intermediate nodes). In the case of constructing a tree structure for use for the search technique 1 according to the embodiment of the present invention, the computer (101) can assign an identifier capable of identifying the groups to each of the nodes (the root node and intermediate nodes) in accordance with the range of the key values of the nodes. For instance, if the key values of a node ranges from 0 to 255, node ID=08 (node having a key only with an 8-bit width); if the values range from 256 to 65535, node ID=16 (node having a key only with a 16-bit width); if the values range from 65536 to 4294967295, node ID=32 (node having a key only with a 32-bit width). The groups can thus be classified into the three types. The identifiers can be used for allowing the computer (101) to traverse the nodes of the constructed tree, identify the group to which each node belongs on the basis of the identifier, and search for data using an instruction (e.g., an SIMD instruction) corresponding to the identified group. For instance, in the case of the identifier “node 08”, the computer (101) uses a SIMD comparison instruction that is for data with an 8-bit width. In the case of the identifier “node 16”, this computer uses a SIMD comparison instruction that is for data with a 16-bit width. In the case of the identifier “node 32”, this computer uses a SIMD comparison instruction that is for data with a 32-bit width. For instance, in the case of comparing the same number of keys, use of a SIMD comparison instruction for data with a 32-bit width only requires execution instructions half as many as instructions in the case of using a SIMD comparison instruction for data with a 16-bit width.

In the case of constructing a tree structure for use for the search technique 2 according to the embodiment of the present invention, the computer (101) constructs each group as a subtree where the root node is a parent node (see the trees (301 and 302) shown in FIGS. 3A and 3B, respectively), or constructs each group as a partial tree (see the tree (303) show in FIG. 3C).

In the case of constructing the tree structure constructed for use for the search technique 2 according to the embodiment of the present invention and constructing each group as a subtree where the root node is a parent node, the computer (101) secures that all prepared types of nodes are allowed to be reached at the parent node at the top of the subtree of each group and that only a specific type of child nodes below the parent node at the top are allowed to be reached. This securement negates the need to check the type of nodes, and enhances the speed of traversing the nodes.

In the case of constructing the tree structure constructed for use for the search technique 2 according to the embodiment of the present invention and constructing each group as a partial tree, the computer (101) secures that all prepared types of nodes are allowed to be reached at the parent node at the top of the (intermediate) nodes of each group and that only a specific type of child nodes below the parent node at the top is allowed to be reached. This securement negates the need to check the type of nodes, and enhances the speed of traversing the nodes.

As shown at block 603, in the case of reconstructing a tree constructed for use for the search technique 1 or 2, the computer (101) determines whether to insert a key into a node of the tree or not. The computer (101) advances the processing to block 604 in response to inserting the key into the node of the tree. Meanwhile, the computer (101) advances the processing to block 605 in response to inserting no key into the node of the tree.

In the case of inserting a key into a node of the tree, the computer (101) causes the keys of the node to be included within a constant range and causes the node to belong to a specific group among the groups. The constant range means that this range allows processing through the same SIMD comparison instruction. For instance, in the case of comparing unsigned integers through a SIMD instruction that has a key value of a 32-bit width capable of comparing 8/16/32-bit width data, the numerical ranges are: 0 to 255; 256 to 65,535; and 65,536 to 4,294,967,295. In the case of comparing signed integers, more specifically, the case of comparing signed integers with a 16-bit width, the numerical ranges are: −32,768 to −129; −128 to 127; and 128 to 32,767.

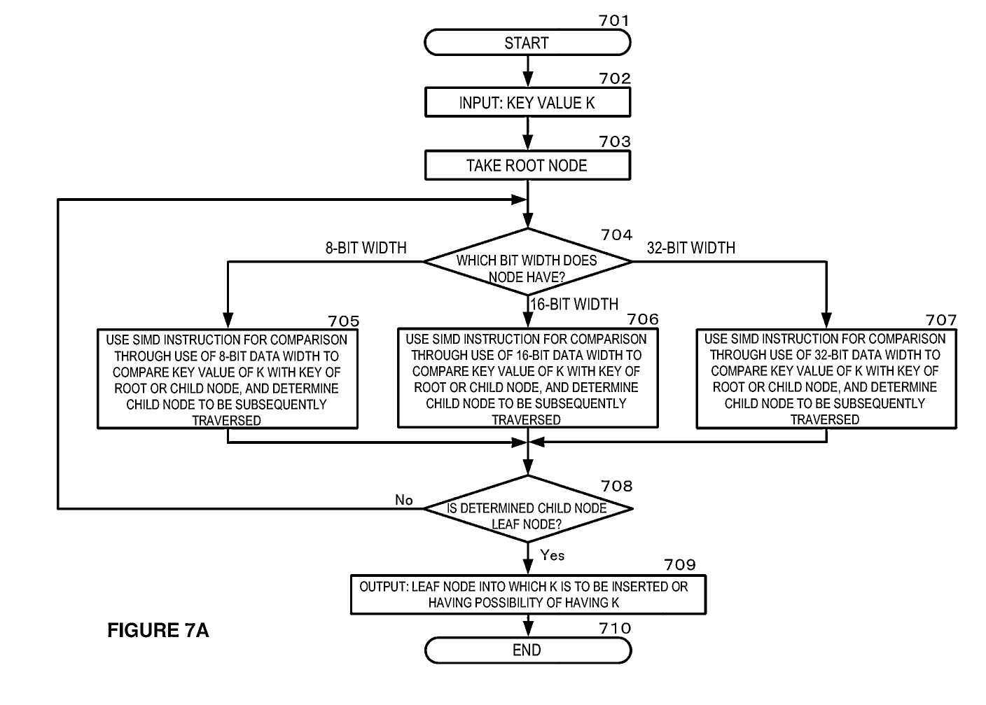

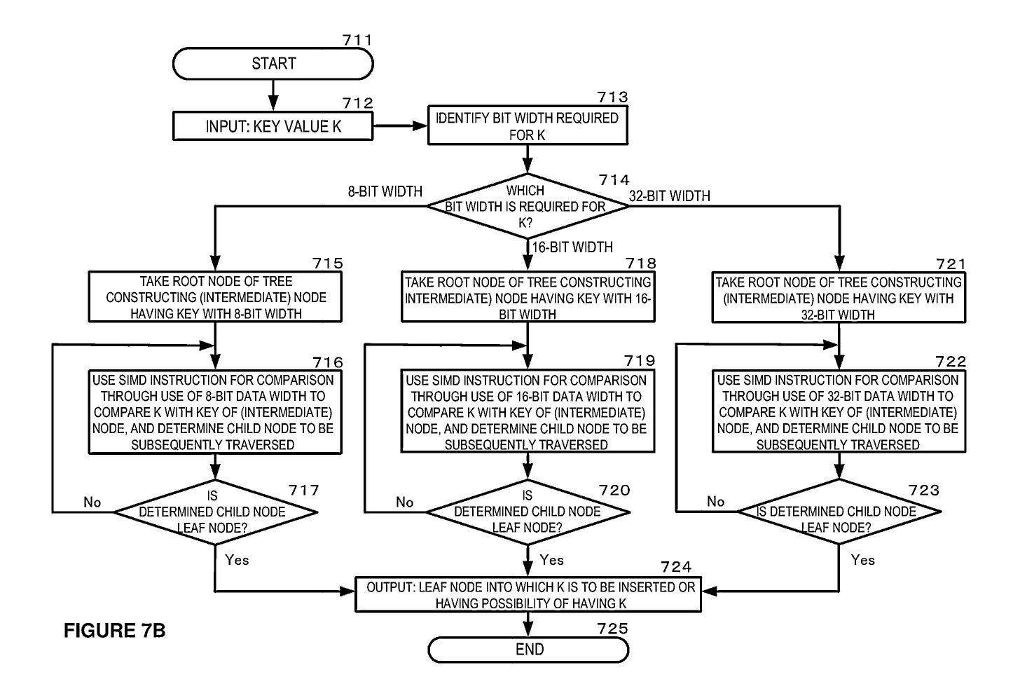

As shown at block 604, the computer (101) inserts a key into a node of the tree in the tree structure constructed for use for the search technique 1 or 2. Insertion of the key into the node of the tree dynamically reconstructs the tree. Processes for inserting a key into a node of the tree will be described in detail with reference to the following FIG. 7A (the search technique 1) and the following FIG. 7B (the search technique 2).

As shown at block 605, the computer (101) determines whether or not to search for data using the tree constructed as shown at block 602 or the tree reconstructed as shown at block 604. The computer (101) advances the processing to block 606 in response to the data search. Meanwhile, the computer (101) advances the processing to block 607 in response to searching for no data.

As shown at block 606, the computer (101) searches the tree constructed as shown at block 602 or the tree reconstructed as shown at block 604, for data in the group with the minimum bit width where the value of the search key is an effective number, using an instruction (e.g., a SIMD instruction) corresponding to the minimum bit width where the value of the search key is the effective number. Through the data search, the key value of K is compared with that of the key of the leaf node to find a leaf node having a possibility of having a key value of K.

As shown at block 607, the computer (101) determines whether to insert a key into the node of the tree to reconstruct the tree or repeat data search. The computer (101) returns the processing to block 603 in response to the reconstruction of the tree or the data search. Meanwhile, the computer (101) advances the processing to block 608 in response to reconstruction of no tree and searching of nothing for data.

As shown at block 608, the computer (101) finishes the processing having been started as shown at block 601. In the flowchart shown in FIG. 6, after construction of the tree shown as shown at block 602, key insertion (hereinafter, referred to as “insertion”) and data search (hereinafter, referred to as “search”) can be performed, for instance, in a following order: (1) insertion→search, (2) insertion→insertion→search, (3) search→insertion, and (4) search→search.

FIG. 7A shows a flowchart of processes of finding a leaf node where the value of a key is to be inserted or a leaf node with a possibility of having the value of a key using a tree structure for the search technique 1 according to the embodiment of the present invention. It is provided that the tree structure constructed for use for the processes shown in FIG. 7A is a B+ tree. The key width of the intermediate node is any of three types, i.e., an 8-bit width, a 16-bit width and a 32-bit width.

As shown at block 701, the computer (101) uses the tree structure for the search technique 1 to start the processing of finding a leaf node where a key value is to be inserted or a leaf node having a possibility of having the key value (which is also identification of the leaf node). As shown at block 702, the computer (101) receives, as an input, the key value of K that a node to be searched has. As shown at block 703, the computer (101) reads the tree structure for the search technique 1 from the memory (103), and takes the root node of the tree.

As shown at block 704 the computer (101) identifies the bit width of the key of the root node taken as shown at block 703 or the child node identified in the following block 705, 706 or 707. The computer identifies the node belonging to the group with the minimum bit width where the key value of K is an effective number. Specific description is as follows. That is, the computer (101) advances the processing to block 705 in response to the bit width of the key of the node being an 8-bit width. The computer (101) advances the processing to block 706 in response to the bit width of the key of the node being a 16-bit width. The computer (101) advances the processing to block 707 in response to the bit width of the key of the node being a 32-bit width. As shown at block 705, in response to the key of the node having an 8-bit width, the computer (101) uses a SIMD instruction for comparison through use of an 8-bit data width on the root node taken as shown at block 703 or a child node determined in the following block 705, 706 or 707, to compare the key value of K with the key of the root or child node (which can be an intermediate node or a leaf node), and identifies a child node to be subsequently traversed.

As shown at block 705, the computer (101) can find a node belonging to the group with the minimum bit width where the key value of K is an effective number. The group with the minimum bit width where the key value of K is the effective number is a group that has the minimum bit width capable of representing the key value of K. As shown at block 706, in response to the key of the node having a 16-bit width, the computer (101) uses a SIMD instruction for comparison through use of a 16-bit data width on the root node taken as shown at block 703 or a child node determined in the following block 705, 706 or 707, to compare the key value of K with the key of the root or child node (which can be an intermediate node or a leaf node), and identifies a child node to be subsequently traversed.

As shown at block 706, the computer (101) can find a node belonging to the group with the minimum bit width where the key value of K is an effective number. The group with the minimum bit width where the key value of K is the effective number is a group that has the minimum bit width capable of representing the key value of K. As shown at block 707, in response to the key of the node having a 32-bit width, the computer (101) uses a SIMD instruction for comparison through use of a 32-bit data width on the root node taken as shown at block 703 or a child node determined in the following block 705, 706 or 707, to compare the key value of K with the key of the root or child node (which can be an intermediate node or a leaf node), and identifies a child node to be subsequently traversed.

As shown at block 707, the computer (101) can find a node belonging to the group with the minimum bit width where the key value of K is an effective number. The group with the minimum bit width where the key value of K is the effective number is a group that has the minimum bit width capable of representing the key value of K. As shown at block 708, the computer (101) determines whether the child node determined as shown at block 705, 706 or 707 is a leaf node. The computer (101) advances the processing to block 709 in response to the child node being a leaf node. In contrast, the computer (101) returns the processing to block 704 to determine a child node to be subsequently traversed, in response to the child node not being a leaf node.

As shown at block 709, the computer (101) regards the child node (which is also a leaf node) determined as shown at block 708 as a leaf node into which a key value of K is to be inserted or a leaf node having a possibility of having a key value of K, for an output. As shown at block 710, the computer (101) finishes the processing having been started as shown at block 701.

FIG. 7B shows a flowchart of processes of finding a leaf node where the value of a key is to be inserted or a leaf node with a possibility of having the value of a key using a tree structure for the search technique 2 according to the embodiment of the present invention.

It is provided that the tree structure constructed for use for the processes shown in FIG. 7B is a B+ tree. The key width of the (intermediate) node is any of three types, i.e., an 8-bit width, a 16-bit width and a 32-bit width. As shown at block 711, the computer (101) uses the tree structure for the search technique 2 to start the processing of finding a leaf node where a key value is to be inserted or a leaf node having a possibility of having the key value. As shown at block 712, the computer (101) receives the key value of K as an input.

As shown at block 713, the computer (101) identifies the bit width required for the key value of K. The computer identifies the node belonging to the group with the minimum bit width where the key value of K is an effective number. Specific description is as follows. That is, the computer (101) determines that the bit width required for K is an 8-bit width in response to the bit width of the key of the node being an 8-bit width. The computer (101) determines that the bit width required for K is a 16-bit width in response to the bit width of the key of the node being a 16-bit width. The computer (101) determines that the bit width required for K is a 32-bit width in response to the bit width of the key of the node being a 32-bit width.

As shown at block 714, the computer (101) advances the processing to block 715 in response to the bit width required for the key value of K being an 8-bit width. The computer (101) advances the processing to block 718 in response to the bit width required for the key value of K being a 16-bit width. The computer (101) advances the processing to block 721 in response to the bit width required for the key value of K being a 32-bit width. As shown at block 715, the computer (101) takes the root node of a partial tree constructing an (intermediate) node with a key of an 8-bit width (or the top node in the case without any root node) in response to the bit width required for K being an 8-bit width.

As shown at block 716, the computer (101) uses a SIMD instruction for comparison through use of an 8-bit data width on the root node taken as shown at block 715 or the child node determined as shown at block 716 executed immediately before the loop of block 716 being executed, to compare the key value of K with the key of the root or child node (which can be an intermediate node or a leaf node), and identify a child node to be subsequently traversed. As shown at block 716, the computer (101) can find a node belonging to the group with the minimum bit width where the key value of K is an effective number. The group with the minimum bit width where the key value of K is the effective number is a group that has the minimum bit width capable of representing the key value of K.

As shown at block 717, the computer (101) determines whether the root or child node determined as shown at block 716 is a leaf node. The computer (101) advances the processing to block 724 in response to the root or child node being a leaf node. In contrast, the computer (101) returns the processing to block 716 to determine a child node to be subsequently traversed, in response to the root or child node not being a leaf node. As shown at block 718, the computer (101) takes the root node of a partial tree constructing an (intermediate) node having a key with a 16-bit width (or the top node in the case without any root node) in response to the bit width required for the key value of K being a 16-bit width.

As shown at block 719, the computer (101) uses a SIMD instruction for comparison through use of a 16-bit data width on the root node taken as shown at block 718 or the child node determined as shown at block 719 executed immediately before the loop of block 719 being executed, to compare the key value of K with the key of the root or child node (which can be an intermediate node or a leaf node), and determine a child node to be subsequently traversed. As shown at block 719, the computer (101) can find a node belonging to the group with the minimum bit width where the key value of K is an effective number. The group with the minimum bit width where the key value of K is the effective number is a group that has the minimum bit width capable of representing the key value of K.

As shown at block 720, the computer (101) determines whether the root or child node determined as shown at block 719 is a leaf node. The computer (101) advances the processing to block 724 in response to the root or child node being a leaf node. In contrast, the computer (101) returns the processing to block 719 to determine a child node to be subsequently traversed, in response to the root or child node not being a leaf node. As shown at block 721, the computer (101) takes the root node of a partial tree constructing an (intermediate) node having a key with a 32-bit width (or the top node in the case without any root node) in response to the bit width required for the key value of K being a 32-bit width.

As shown at block 722, the computer (101) uses a SIMD instruction for comparison through use of a 32-bit data width on the root node taken as shown at block 721 or the child node determined as shown at block 722 executed immediately before the loop of block 722 being executed, to compare the key value of K with the key of the root or child node (which can be an intermediate node or a leaf node), and determine a child node to be subsequently traversed. As shown at block 722, the computer (101) can find a node belonging to the group with the minimum bit width where the key value of K is an effective number. The group with the minimum bit width where the key value of K is the effective number is a group that has the minimum bit width capable of representing the key value of K.

As shown at block 723, the computer (101) identifies whether the root or child node determined as shown at block 722 is a leaf node. The computer (101) advances the processing to block 724 in response to the root or child node being a leaf node. In contrast, the computer (101) returns the processing to block 722 to determine a child node to be subsequently traversed, in response to the root or child node not being a leaf node. As shown at block 724, the computer (101) regards the child node (which is also a leaf node) determined as shown at block 717, 720 or 723 as a leaf node into which a key value of K is to be inserted or a leaf node having a possibility of having a key value of K, for an output. As shown at block 725, the computer (101) finishes the processing having started as shown at block 711.

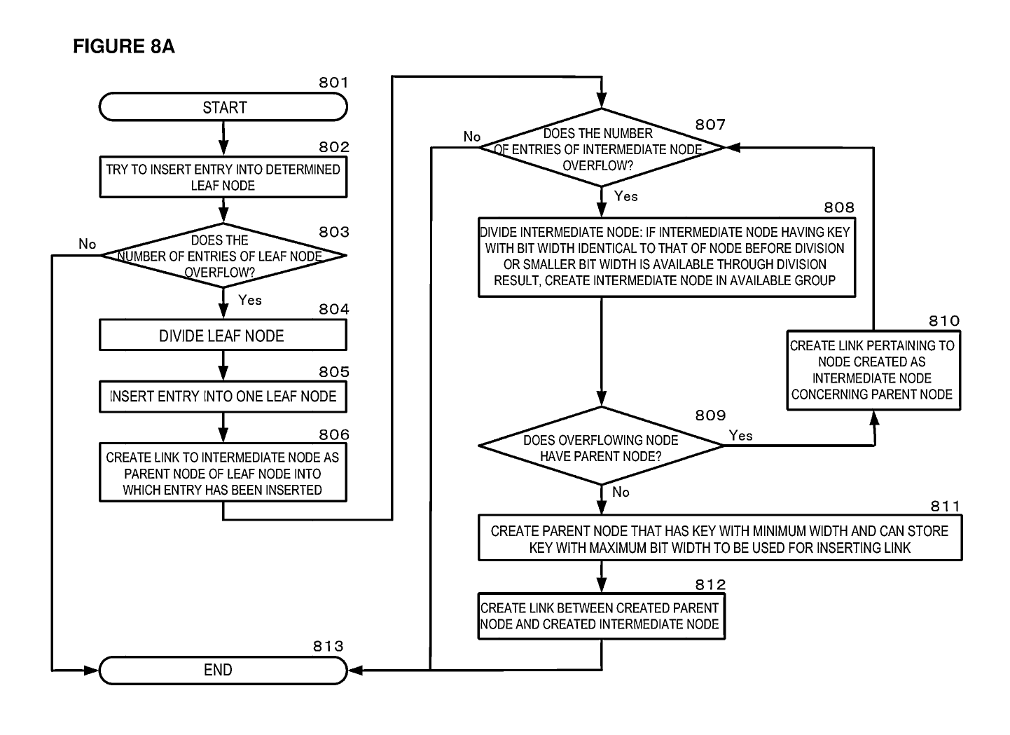

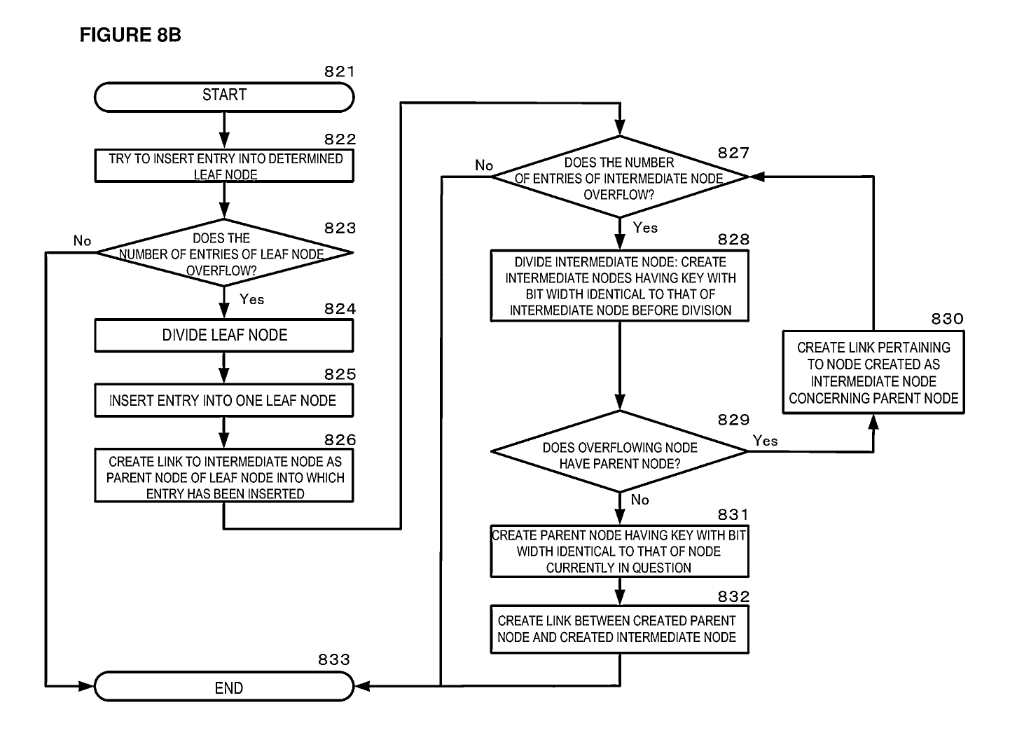

FIG. 8A shows a flowchart of processes of dynamically reconstructing a tree by inserting an entry into a node of the tree in a tree structure constructed for use for the search technique 1 according to an embodiment of the present invention. It is provided that the tree structure constructed for use for the processes shown in FIG. 8A is a B+ tree. The key width of the intermediate node is any of three types, i.e., an 8-bit width, a 16-bit width and a 32-bit width. As shown at block 801, the computer (101) starts processes of inserting an entry into a node of the tree in a tree structure constructed for use for the search technique 1 to dynamically reconstruct a tree (corresponding to the process of block 1B shown in FIG. 4E).

As shown at block 802, the computer (101), for instance, tries to insert an entry into the leaf node (i.e., the leaf node into which the key value of K is to be inserted) output as shown at block 709 shown in FIG. 7A (corresponding to the process of block 1B shown in FIG. 4E).

As shown at block 803, the computer (101) tries to insert an entry into the leaf node to thereby determine whether the number of entries of the leaf node overflows or not (corresponding to the process of block 2B shown in FIG. 4E). The computer (101) advances the processing to block 804 for performing a process of dividing the leaf node, in response to the number of entries of the leaf node overflowing. In contrast, the computer (101) inserts the entry into the leaf node in response to the number of entries of the leaf node not overflowing, and advances the processing to finish block 813.

As shown at block 804, the computer (101) divides the leaf node into two leaf nodes (corresponding to the process of block 2B shown in FIG. 4E). As shown at block 805, the computer (101) inserts an entry into one of the two leaf nodes generated by the division (corresponding to the process of block 2B shown in FIG. 4E). As shown at block 806, the computer (101) creates a link to the intermediate node as the parent node of the leaf node into which the entry has been inserted (corresponding to the process of block 3B shown in FIG. 4E). As shown at block 807, the computer (101) makes the link to the intermediate node to thereby determine whether the number of entries of the intermediate node overflows or not (corresponding to the processes of blocks 4B and 6B shown in FIG. 4E). The computer (101) advances the processing to block 808 for performing a process of dividing the intermediate node, in response to the number of entries of the intermediate node overflowing. In contrast, the computer (101) makes a link to the intermediate node that is the parent node of the leaf node into which the entry has been inserted in response to the number of entries of the intermediate node not overflowing, and advances the processing to finish block 813.

As shown at block 808, the computer (101) divides the intermediate node into two intermediate nodes. If the intermediate node having a key with a bit width identical to that of the intermediate node before division or the intermediate node having a key with a smaller bit width is available through the division result, the computer creates an intermediate node belonging to the available group (corresponding to the processes of blocks 4B and 6B shown in FIG. 4F).

As shown at block 809, the computer (101) determines whether the overflowing node has a parent node or not (corresponding to the processes of blocks 4B and 6B shown in FIG. 4F). The computer (101) advances the processing to block 810 in response to the overflowing node having a parent node. In contrast, the computer (101) advances the processing to block 811 in response to the overflowing node having no parent node. As shown at block 810, the computer (101) creates a link pertaining to the node created as an intermediate node of the parent node (corresponding to the process of block 5B shown in FIG. 4F). The computer (101) advances the processing to block 807 to try to make a link to the intermediate node, thereby determining whether the number of entries of the intermediate node overflows or not. Subsequently, the computer (101) repeats the processes on and after block 808.

As shown at block 811, the computer (101) creates a parent node that has a key with the minimum width and can store a key with the maximum bit width to be used for inserting a link (corresponding to the process of block 7B shown in FIG. 4G (creation of the parent node (459))). As shown at block 812, the computer (101) creates a link between the parent node created as shown at block 811 and the intermediate node created as shown at block 808 (corresponding to the process of block 7B shown in FIG. 4G (creation of a link between the parent node (459) and the intermediate node (457))). As shown at block 813, the computer (101) finishes the processing having been started as shown at block 801.

FIG. 8B shows a flowchart of processes of dynamically reconstructing a tree by inserting an entry into a node of the tree in a tree structure constructed for use for the search technique 2 according to an embodiment of the present invention. It is provided that the tree structure constructed for use for the processes shown in FIG. 8B is a B+ tree. The key width of the intermediate node is any of three types, i.e., an 8-bit width, a 16-bit width and a 32-bit width. As shown at block 821, the computer (101) starts processes of inserting an entry into a node of the tree in a tree structure constructed for use for the search technique 2 to dynamically reconstruct a tree (corresponding to the process of block 1D shown in FIG. 5C).

As shown at block 822, the computer (101), for instance, tries to insert an entry into the leaf node (i.e., the leaf node into which the key value of K is to be inserted) output as shown at block 724 shown in FIG. 7B (corresponding to the process of block 1D shown in FIG. 5C). As shown at block 823, the computer (101) tries to insert an entry into the leaf node to thereby determine whether the number of entries of the leaf node overflows or not (corresponding to the process of block 2D shown in FIG. 5C). The computer (101) advances the processing to block 824 for performing a process of dividing the leaf node, in response to the number of entries of the leaf node overflowing. In contrast, the computer (101) inserts the entry into the leaf node in response to the number of entries of the leaf node not overflowing, and advances the processing to finish block 833.

As shown at block 824, the computer (101) divides the leaf node into two leaf nodes (corresponding to the process of block 2D shown in FIG. 5C). As shown at block 825, the computer (101) inserts an entry into one of the two leaf nodes generated by the division (corresponding to the process of block 2D shown in FIG. 5C). As shown at block 826, the computer (101) creates a link to the intermediate node as the parent node of the leaf node into which the entry has been inserted (corresponding to the process of block 3D shown in FIG. 5D).

As shown at block 827, the computer (101) makes the link to the intermediate node to thereby determine whether the number of entries of the intermediate node overflows or not (corresponding to the processes of blocks 4D and 6D shown in FIG. 5D). The computer (101) advances the processing to block 828 for performing a process of dividing the intermediate node, in response to the number of entries of the intermediate node overflowing. In contrast, the computer (101) makes a link to the intermediate node that is the parent node of the leaf node into which the entry has been inserted in response to the number of entries of the intermediate node not overflowing, and advances the processing to finish block 833.

As shown at block 828, the computer (101) divides the intermediate node into two intermediate nodes to thus create the intermediate nodes having a key with a bit width identical to the width of the intermediate node before division (corresponding to the processes of blocks 4D and 6D shown in 5D). As shown at block 829, the computer (101) determines whether the overflowing node has a parent node or not (corresponding to the processes of blocks 4D and 6D shown in FIG. 5D). The computer (101) advances the processing to block 830 in response to the overflowing node having a parent node. In contrast, the computer (101) advances the processing to block 831 in response to the overflowing node having no parent node.

As shown at block 830, the computer (101) creates a link pertaining to the node created as an intermediate node concerning the parent node (corresponding to the process of block 5D shown in FIG. 5D). The computer (101) advances the processing to block 827 to try to make a link into the intermediate node, thereby determining whether the number of entries of the intermediate node overflows or not. Subsequently, the computer (101) repeats the processes on and after block 828. As shown at block 831, the computer (101) creates a parent node having a key with the bit width identical to the width of the node currently in question (corresponding to the process of block 6D shown in 5D (creation of the parent node (547))). As shown at block 832, the computer (101) creates a link between the parent node created as shown at block 831 and the intermediate node created as shown at block 820 (corresponding to the process of block 7D shown in FIG. 5E (creation of a link between the parent node (547) and the intermediate node (546))). In block 833, the computer (101) finishes the processing having been started as shown at block 821.

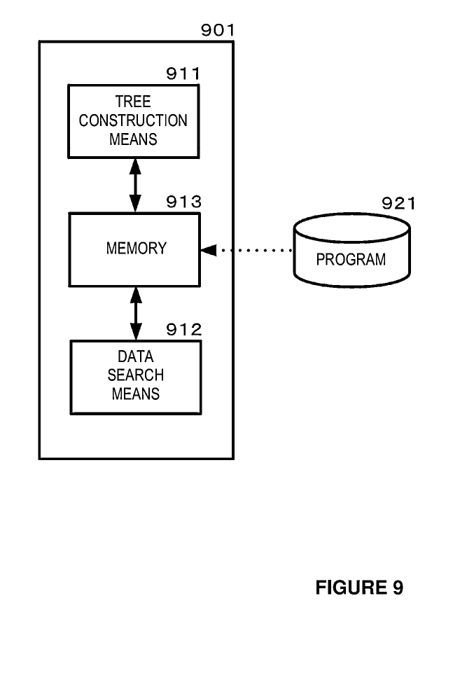

FIG. 9 is a diagram showing an example of a functional block diagram of a computer that preferably has a hardware configuration according to FIG. 1 and is for searching a tree using an instruction of operating data having predetermined multiple bit widths according to an embodiment of the present invention. The computer (901) is a computer for searching a tree using an instruction of operating data having predetermined multiple bit widths according to the embodiment of the present invention, and is, for instance, the computer (101) according to FIG. 1. The computer (901) includes tree construction means (911) and data search means (912), and a memory (913). The tree construction means (911) classifies the nodes of the tree into groups having the minimum bit width capable of representing the key value among the multiple bit widths, and constructs the tree.

The tree construction means (911) inserts the key into the node belonging to the group with the minimum bit width where the value of the key to be inserted is an effective number. The tree construction means (911) finds the node belonging to the group with the minimum bit width where the key value is an effective number. The group with the minimum bit width where the key value is the effective number is a group that has the minimum bit width capable of representing the value of the key to be inserted.

The tree construction means (911) divides the found node or the parent node of the found node in response to the found node overflowing due to insertion of the inserted key. The tree construction means (911) arbitrarily assigns identifiers for identifying the group to the respective nodes, in order to construct the tree according to the search technique 1 (see FIG. 2).

The tree construction means (911) constructs the tree such that the nodes other than the root node of the tree have the minimum bit width capable of representing the key value among the multiple bit widths, in order to construct the tree according to the search technique 1 (see FIG. 2). The tree construction means (911) constructs the tree such that the root node of the tree has, as child nodes, at least two groups with the minimum bit width capable of representing a key value among the multiple bits, in order to construct the tree according to the search technique 1 (see FIG. 2).

The tree construction means (911) constructs each group as a subtree where the root node is the parent node, in order to construct the tree according to the search technique 2 (see FIGS. 3A and 3B). The tree construction means (911) constructs each group as a partial tree, in order to construct the tree according to the search technique 2 (see FIG. 3C). The tree construction means (911) can execute blocks 602 to 604 shown in FIG. 6, all the blocks shown in FIG. 7A (the process of finding a leaf node into which the key value of K is to be inserted, and the process of finding a leaf node having a possibility of having the key value of K), all the blocks shown in FIG. 7B (the process of finding the leaf node into which the key value of K is to be inserted, and the process of finding a leaf node having a possibility of having the key value of K), and all the blocks shown in FIG. 8A and all the blocks shown in FIG. 8B.

The data search means (912) searches for data in the group having the minimum bit width where the value of the search key is an effective number, using the instruction corresponding to the group with the minimum bit width where the value of the search key is an effective number.

In a tree which is constructed for the search technique 1 and in which an identifier for identifying the group is assigned to each node of the tree (see FIG. 2), the data search means (912) traverses the nodes of the constructed tree, identifies the group to which each node belongs on the basis of the identifier, and searches for the data using the instruction corresponding to the identified group.

In the tree constructed for the search technique 2 (see FIGS. 3A and 3B), the data search means (912) searches for the data using the instruction corresponding to the subtree (e.g., a SIMD instruction). In the tree constructed for the search technique 2 (see FIG. 3C), the data search means (912) searches for the data using the instruction corresponding to the partial tree (e.g., a SIMD instruction). The data search means (912) can execute block 605 shown in FIG. 6.

The computer (901) reads a program for tree construction from a storage medium (921) into the memory (913), and passes the program having been read into the memory (913), to the tree construction means (911). The computer (901) stores the tree constructed by the tree construction means (911) in the memory (913) in order to allow the data search means (912) to search for data.

In IBM (registered trademark) Cognos (registered trademark) Business Intelligence 10.2.1, through use of a benchmark program based on a TPC-DS benchmark, a process of inserting a key into a tree spends 15% of the execution time of the program. Accordingly, also for the sake of speedup of IBM (registered trademark) Cognos (registered trademark) Business Intelligence 10.2.1, speedup of an operation of inserting an entry into a node of a tree in a tree structure becomes important. In the benchmark program, about 666,000 entries are inserted into nodes in the tree several times. A single benchmark program is prepared that is written in the C language, acquires the sequence of keys used for the insertion of about 666,000 entries, and executes the insertion into the nodes of the tree using the same sequence of keys.

Through use of a tree used for the search technique 2 according to the embodiment of the present invention and through use of a tree constructed according to a conventional technique, the single benchmark program is executed on a POWER7. More specifically, the execution is focused on comparison of long keys; the comparison is performed between a SIMD B+ tree for only comparing keys with a 32-bit width or a 64-bit width according to the embodiment of the present invention and a SIMD B+ tree for only comparing keys with a 64-bit width according to the conventional technique. As a result, in the case of using the tree used for the search technique 2 according to the embodiment of the present invention, the execution time decreases by 41.2% in comparison with the case of using the tree constructed according to the conventional technique

1. A method of searching a tree using an instruction of operating data having predetermined multiple bit widths, the method, executed by a computer, comprising:
constructing the tree by classifying nodes of the tree into groups having a minimum bit width capable of representing a value of a key among the multiple bit widths; and
searching for data in the group having the minimum bit width with a value of a search key being an effective number, using the instruction corresponding to the group having the minimum bit width with the value of the search key being the effective number.

2. The method according to claim 1, wherein the constructing further includes inserting a key to be inserted into a node belonging to the group having the minimum bit width with the value of the key to be inserted being an effective number.

3. The method according to claim 2, wherein the constructing further includes finding a node belonging to the group having the minimum bit width with the key value being the effective number, wherein the group having the minimum bit width with the key value being the effective number is a group having the minimum bit width capable of representing the value of the key to be inserted.

4. The method according to claim 3, wherein the constructing further includes dividing the found node or a parent node of the found node in response to the found node overflowing due to the insertion of the key to be inserted.

5. The method according to claim 1, wherein the constructing further includes assigning identifiers for identifying the groups to the respective nodes, and the searching further includes identifying the group to which each node belongs on the basis of the identifier by traversing the nodes of the constructed tree, and searching for the data using an instruction corresponding to the identified group.

6. The method according to claim 1, wherein the constructing further includes constructing the tree such that nodes other than a root node of the tree have the minimum bit width capable of representing the value of the key among multiple bit widths.

7. The method according to claim 1, wherein the constructing further includes constructing each group as a subtree with the root node being a parent node, and the searching further includes searching for the data using the instruction corresponding to the subtree.

8. The method according to claim 1, wherein the constructing further includes constructing each group as a partial tree, and the searching further includes searching for the data using the instruction corresponding to the partial tree.

9. The method according to claim 1, wherein the instruction is a SIMD (Single Instruction Multiple Data) instruction.

10. The method according to claim 1, wherein the bit width is an 8-bit width, a 16-bit width, a 32-bit width, a 64-bit width, a 128-bit width or a 256-bit width.

11. A computer for searching a tree using an instruction of operating data having predetermined multiple bit widths, comprising:
tree construction means for constructing the tree by classifying nodes of the tree into groups having a minimum bit width capable of representing a value of a key among the multiple bit widths; and
data search means for searching for data in the group having the minimum bit width with a value of a search key being an effective number, using the instruction corresponding to the group having the minimum bit width with the value of the search key being the effective number.

12. The computer according to claim 11, wherein the tree construction means inserts a key to be inserted into a node belonging to the group having the minimum bit width with the value of the key to be inserted being an effective number.

13. The computer according to claim 12, wherein the tree construction means finds a node belonging to the group having the minimum bit width with the key value being the effective number, wherein the group having the minimum bit width with the key value being the effective number is a group having the minimum bit width capable of representing the value of the key to be inserted.

14. The computer according to claim 13, wherein the tree construction means divides the found node or a parent node of the found node in response to the found node overflowing due to the insertion of the key to be inserted.

15. The computer according to claim 11, wherein the tree construction means assigns identifiers for identifying the groups to the respective nodes, and the data search means identifies the group to which each node belongs on the basis of the identifier by traversing the nodes of the constructed tree, and searches for the data using an instruction corresponding to the identified group.

16. The computer according to claim 11, wherein the tree constructing means constructs the tree such that nodes other than a root node of the tree have the minimum bit width capable of representing the value of the key among multiple bit widths.

17. The computer according to claim 11, wherein the tree construction means constructs each group as a subtree with a root node being a parent node, and the data search means searches for the data using the instruction corresponding to the subtree.

18. The computer according to claim 11, wherein the tree construction means constructs each group as a partial tree, and the data search means searches for the data using the instruction corresponding to the partial tree.

19. The computer according to claim 11, wherein the instruction is a SIMD (Single Instruction Multiple Data) instruction.

20. A computer program for searching a tree using an instruction of operating data having predetermined multiple bit widths, causing a computer to execute the method according to claim 1.
